(19) United States
(12) Patent Application Publication
(10) Pub. No.: US 2013/0293368 A1
(43) Pub. Date: Nov. 7, 2013

(54) Esom security

(71) Applicants: Chikezie Ottah, Dallas, GA (US); Esom Ottah, Dallas, GA (US); Kenneth Ottah, Enugu (NG); Chika Ottah, Enugu (NG); Raquel Laine, Dallas, GA (US); Christy Ottah, Brooklyn, NY (US)

(72) Inventors: Chikezie Ottah, Dallas, GA (US); Esom Ottah, Dallas, GA (US); Kenneth Ottah, Enugu (NG); Chika Ottah, Enugu (NG); Raquel Laine, Dallas, GA (US); Christy Ottah, Brooklyn, NY (US)

(21) Appl. No.: 13/573,380

(22) Filed: Sep. 13, 2012

Related U.S. Application Data
(60) Provisional application No. 61/626,054, filed on Sep. 20, 2011.

(51) Int. Cl. G08B 23/00

(52) U.S. Cl. CPC G08B 23/00
USPC 340/426.1

(57) ABSTRACT

Disclosed is smart lock technology that may be installed into vehicles or homes independently. The smart lock technology can be incorporated into, attached to, or built into doors, gates, windows, walls, glasses, etc.

### CROSS REFERENCE TO RELATED APPLICATIONS

This application claims the priority benefit of U.S. Provisional Application No. 61/626,054 filed on Sep. 20, 2011.

### FIELD OF THE INVENTION

The disclosed invention relates to new lock technology systems for homes and vehicle. Computer and electronic devices provide engineered locking methods which communication, media exchange locally or broad band, wired or wireless to the occupant device, other computer(s) and electronic, through a configured sensor motion detector, light, voice, video and picture to the locking systems like pad lock, key lock, combination, door lock, remote control and or it locking body(s) doors, gates, garages, and windows, glass, mirror. Other elements that combined to forge the locking body technology systems, the invention is new to locking technology systems in a buildings or mobile vehicles. Conventional doors, windows, gates (inbuilt or independent) locks have lacked the improved computers, or electronics, or HDTV technological devices of today and tomorrow, the new devices provide all in one technology, wired and wireless media, camera, voice, video, data, alarm, motion detector, smoke detectors, carbon monoxide detector, in parts or once in the locking systems of a vehicle or a building or a home lock system door, window, gates or independent lock pads. Notable today, Homes, buildings, and vehicles for occupant the new lock is durable, secured, affordable and reliable to provide security to all the mention entrances or egress. The present invention is not federally sponsored.

### BACKGROUND OF THE INVENTION

The locking technologies is an old industry, from pad lock technology system to numerical combination locking technology system. 97 percents of intruder occurs from the doors, windows, gates, or garages and less informative locks does not retard, prevent, or protect owners and or their properties from the intruder, this deficiencies in doors, windows, gates, garages, trunks, boot etc. in homes and vehicles was not addressed by these prior act. These are well documented building, home or vehicle security technologies as s follows: U.S. Pat. No. 7,561,019, U.S. Pat. No. 7,081,813, U.S. Pat. No. 6,377,173, U.S. Pat. No. 5,307,048, U.S. Pat. No. 5,467,070, U.S. Pat. No. 5,049,867, U.S. Pat. No. 5,253,341, U.S. Pat. No. 4,141,010, U.S. Pat. No. 4,143,368, U.S. Pat. No. 4,159,467, U.S. Pat. No. 3,805,238, U.S. Pat. No. 4,006,459, U.S. Pat. No. 4,581,634, U.S. Pat. No. 4,858,000, U.S. Pat. No. 4,879,747, U.S. Pat. No. 4,975,081, U.S. Pat. No. 5,099,508, U.S. Pat. No. 5,095,196, U.S. Pat. No. 5,245,329, U.S. Pat. No. 6,026,188, U.S. Pat. No. 6,026,193, and U.S. Pat. No. 6,324,573.

### SUMMARY OF THE INVENTION

The prior arts both in buildings, homes or vehicles key pads locks, door locks, combinations and the likes do not have HDTV, LCD (LED) screen pictures, video, or media that show the intruder, him/her self in minutes before the crime is committed.

The new small key on the door, window, gate, pad lock device, control, or LCD PAD, HDTV focused on the intruder outside and inside the premises with voice, video, pictures, alarm warning the intruder(s).

The digital (computerized control or pad) HDTV, or LCD video, voice, picture, and data will be informing the intruder how much, time before the 1^{st} responders (police) arrive at the location.

Privately or in house located HDTV with link application may be remotely activated to let the intrude know, watch his/her picture or video as be monitored by the authorities.

The new locking technology tend to correct deficient of the old locking technologies by educating the public through interactive voice, pictures and videos messages or warning or instructions for safety.

The new locking technology educate and provide information (to law enforcement) to the public with the interactive media exchange.

The new locking technology through education and information warn a criminal against the act of crime. A lot of young single (females) people are buying homes, flashy vehicles and buildings.

The old locking technology system only does the physical locking of properties and life interior, but the new invention provides an enhance technological devices that deliver time, act, voice, video and images to the young single occupant home, vehicle or building owner via cell phone and other computers or electronics devices in the seconds before any body is in ham's away.

The new smart locking device may be capable of camera, motion, light and or laser detector and captured, picture, carbon dioxide, carbon monoxide.

The new locking technology device may be capable of night mode vision, and produce a high quality timed, images, voice and or video through a server, computer, electronic camera or video (lens), voice and time. The technology may be plug and play.

The new locking technology devices may store media in a local memory, chips, external receivers, like computers, electronic, cell phone, phone, remote printer, Twitter, e-mail, Facebook, police, any address assigned.

The new locking technology devices may have the capability of delivery media captured during criminal act to an outside receivers in slow or still imaging and life version.

External smart HDTV, iPad, electronics, computers, smart Adopter and camera may be integrated to function with the invention.

The new smart lock device, may be equipped and capable of using power from AC, DC and solar power source(s).

The new smart lock technology devices may be independent or attach or built in part(s) or all parts assembled into a doors, gates, windows or independent locking pads, locking combination and other locking devices.

It may be body or voice recognizable activation technology equipped, in the new smart lock system.

LCD or HDTV screen, screen lock code, remote, punch button, timex with activation programming and energy saving mold technology may be available to the new smart lock.

Desktop or directory programming or application may be available at the control item, or remotely connect to phone, cell phone, electronic or computer devices.

The new smart lock technology may produce or provide media quality like HDTV, computers electronics and others with clear digital technologies.

The new smart lock technology may be used for in-house or private or public social activities and reaching families and Mends.

The new smart lock technology may exchange media or communicate, camera, video, voice, 4G, Skype, MIG 3, CAM, GSM, WiFi, and more may be wired and or wireless.

The new smart lock technology may use computer or electronic device(s) to upgrade and improve a new doors, gates, garages, mobile or home.

This new smart lock, protective, or security device may have GPS technology, plus camera, voice and video, which is accessible in hand held electronics, computers or cell phone to communicate via Twitter, Facebook, e-mail, text, etc.

The new smart lock technology may have capability to detect smoke, carbon monoxide and fire, may work with or manage other home or vehicle appliances.

The new smart lock technology may have the capability to direct residents to safety through an automated application like GPS device of home base, home directory seen in a digital HDTV or LCDS screen provided at the door lock or door premises or private hand held devices like cell or phone, as the occupant wish.

These new smart lock technology may be installed in a vehicles or homes independently, incorporated, attached or inbuilt into doors, gates, windows, walls. Slide, Pull, Push, revolving, electric, air, or motorized doors, windows, gates and others may be glasses, mirror or inbuilt Esom's security apparatus.

The new smart lock and key technology may be operational with like of 4G or android satellite Technology, access or arm or disarm using linked wired or wireless, computer, electronic, including hand held devices.

Esom security device may be cased or coupled inside the lock, base or other hidden areas of the doors, windows, and gates, wall and vehicle. Materials may be metal, cooper, aluminum, wood, titanium, leather, cloth, plastic, rubber, and foam.

The new smart lock pad with HDTV, LCD, windows, gates or doors may operated by electronic or remote control, cell phone, internet by a secured code (in a Vehicle, and Building).

The new smart door locks, electronic and computer operating system may be use to add or connecting to multiple new and improved device(s), including serial port, VGA, USB port, etc.

The new smart door locks, electronic, or computer system may enabled or disable for example a manual mode off/on, log off/in any device, up/downgrade control devices or glowing light pad operating buttons with LCD, voice, video, satellite, master code device may regulate in control.

To save life and property of these young people, cell phone WiFi security services and other satellite, GPS technology are free, they can view their homes, buildings, vehicles before and after contact.

On and off switches) in selected area(s) by cell phone, remote control, and or manual (pad button) may be using master code in control.

The connection may be digitally centralized or decentralized configuration or assembled of devices and or broadcast.

The LCD (LED) screens or pad or HDTV may be equipped with water-proof, shock-proof and freeze-proof stop material(s).

### BRIEF DESCRIPTION OF THE DRAWINGS

FIG. 1 is an exploded view of the invention.

FIG. 2 is a side view of a second embodiment of the invention.

FIG. 3 is a side view of a third embodiment of the invention.

FIG. 4 is the prospective of a fourth embodiment of the invention.

FIG. 5 is a prospective view of a fifth embodiment of the invention.

FIG. 6. is an exploded view of a sixth embodiment of the invention.

FIG. 7 is a side view of a seventh embodiment of the invention.

FIG. 8 is a schematic exploded view of Esom security apparatus according to and eighth embodiment of the present invention.

FIG. 9. is a schematic perspective view of Esom security apparatus according to a ninth embodiment of the present invention.

FIG. 10 is an exploded, perspective view of Esom security apparatus according to a tenth embodiment of the present invention.

FIG. 11. is a schematic perspective view of Esom security apparatus according to an eleventh embodiment of the present invention.

FIG. 12A is a perspective view of Esom security apparatus according to a twelfth embodiment of the present invention.

FIG. 12 B is another perspective view of Esom security apparatus according to the twelfth embodiment of the present invention.

FIG. 13A is an elevation view of Esom security apparatus according to a thirteenth, embodiment of the present invention.

FIG. 13B is another elevation view of Esom security apparatus according to the thirteenth embodiment of the present invention.

FIG. 14 is a perspective view of Esom security apparatus according to a fourteenth embodiment of the present invention.

FIG. 15 is a perspective view of Esom security apparatus according to a fifteenth embodiment of the present invention.

FIG. 16 is an elevational view of a sixteenth embodiment of Esom security apparatus.

FIG. 17 is a front view of the Esom security apparatus of FIG. 16.

FIG. 18 is a perspective view of a seventeenth embodiment of the invention.

FIG. 19 is an exploded view of an eighteenth embodiment of the invention.

FIG. 20 is a side view of a base for the Esom security apparatus.

FIG. 21 is a side view of a base for the Esom security apparatus.

FIG. 22 a side view of a base for the Esom security apparatus according.

FIG. 23 is a front view of a mother board for the Esom security apparatus.

FIG. 24 is a front view of Esom security lock apparatus according to a nineteenth embodiment of the invention.

FIG. 25 is an exploded front view of Esom door security apparatus according to a twentieth embodiment of the present invention.

FIG. 26 is a front view of Esom lock security apparatus according to a twenty-first embodiment of the invention.

FIG. 27 is a front view of Esom portable screen view according to an twenty-second embodiment of the invention.

FIG. 28 is a top view of Esom security safe deposit box according to a twenty-third embodiment of the invention.

FIG. 29 is a side view of Esom lock, door apparatus according to a twenty-fourth embodiment of the invention.

### DETAILED DESCRIPTION OF THE INVENTION

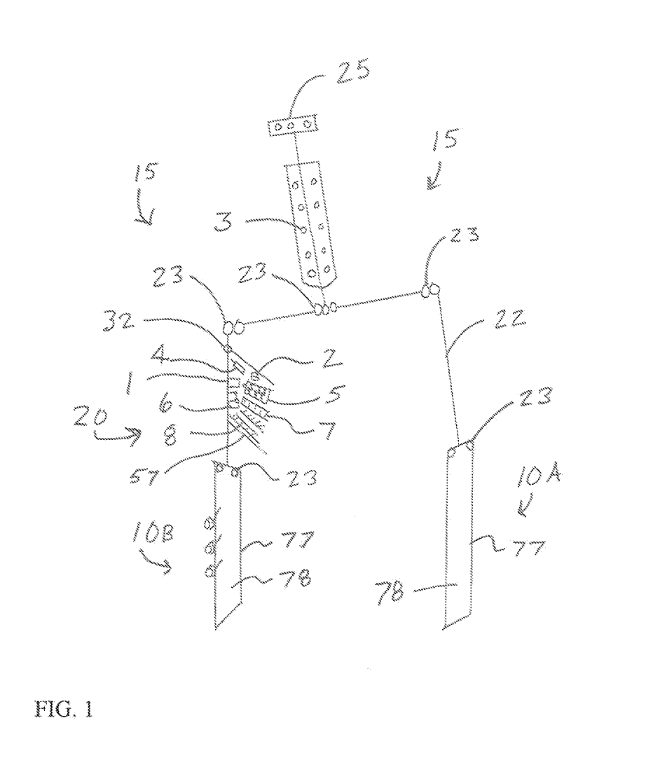

FIG. 1, 10A is 77 one system of the 24 locking technology assembled, 22 this system of the technology is used by applying the 24 claw to rest 23 in any position from the door to frame, 10A in tight squeezing motion, into a hole or other rest position on the frame and or door or wall restricting the movement of the door or apply a dead bolt like lock on the door, window or gate. 24 the claw may be used as a base for computer and or electronic, or motor power devices, or receiver 20 of all images of an intruder taken 29 by the front door base 29 camera. 11A front door liner or baseboard 25 11A may be attached or used to anchored the invention on the floor with rivet, screwed, or other mechanical method (to the wall as well as a baseboard, floor or the door). 11A electronic and computer add strength and stability and provide early warning to an intruder, 11A and 11B may be wired or wireless technological devices. 22 The handle is used when 23 adjusting the 15 body to flex in gripping position toward the doors, gates, and garages in rigid locking position.

Continue with FIG. 1. 10B the other half of the locking device technology, the 78 claw may be on the opposite side of the wall or inside the door (not shown), 23 it joint or assembled to tight squeeze the wall and the door, or gate in a locking position. 20 The technological device installed, 29 may be capable of carrying 34 image, voice and video, the motion sensor (not shown) alert the device 30 of an intruder, 31 the device trigger sensor 30 and secure light, then the camera to start 29 snapping pictures or video and announcement (the camera may be capable of snapping over 4,000 peeps or motion recording mode). 77 The images may be sent into a secured receiver, example personal phone, YouTube, Facebook, police secured receiver.

Continue with FIG. 1. And FIG. 1, may operate and powered with an electronic or motor, (not shown) 22 the electronic or motorized system 23 will operate the bionic movements 15 of the invention, 15 the entire system could be in built into a door, gate and or window and operation columns or skeleton. 57 columns the operating system (computer or electronics or other devices) may be inbuilt and the lid 31 joint or separate coupled into a case to rest into the 15 body may be equipped with USB port, Serial port etc. (not shown).

The 12 invention may be screwed or riveted, other mechanisms or inbuilt into the door or gate or window or garage door, tent entrance or exist, 5 the rod like structure projecting from internal 23 and external sides of the door, gate, window, 10A and 10B the claw leave their secured pockets 22A and enter a pocket inside 22B the door, gate, and window and or door, only the camera, voice, video and the motion detector may have a cut out opening and or a transparent covered material, example clear plastic, or glass.

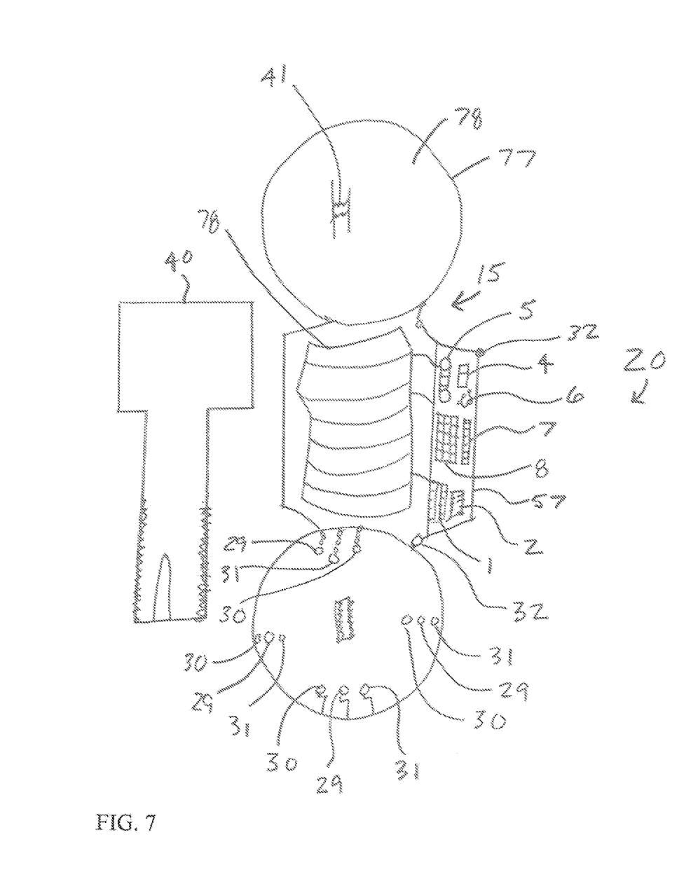

The device system 20, example may include a security 6 server, cimeos, cameras, memory, (1 CPU), 4 batteries, 9 transmitter, transducer, amplifier, 34 speaker, AC, DC, storage card or chip, motion sensor, audio equipment, and electronic equipment. The device may be capable of wired and wire-less. The camera may be capable to turn, and rotate to capture images on any direction motion sensor(s) picked movement. (FIG. 1 and FIG. 7).

Esom's new lock security apparatus installed on every home as mention above with new upgrade lock technologies may be configured to better serve the occupant, a powerful 8 processor (1 hard drive). The 8 processor perform high valuable job, 8 the processor receive, interpret, direct the message to appropriate receivers), before than 29 the media (34 voice, audio, video, and photo may be captured by using night vision detector, leaser, or motion detector (or other means), may be an affordable auto configured 29 camera, 31 flash, and 30 laser guide sensor and or night vision equipment. The 29 camera is configured to respond to the reaction of 30 the light and leaser, or other sensitive 29 camera equipment. Once all the information is feed into the 8 processor, the 8 processor programmed to determine the danger or damage, or accident, break in the lock. The 8 processor will transmit 9 the media 7 in the language(s) to the receivers like cell phone, e-mail, printer, Facebook. Twitter, taxi insurance company, police etc. 2 the fan system cool the 4 power (AC, DC, or Solar), the refreshed energy enable configured technology, media or communication in wired and or wireless. The 8 processor or 1 hard drive may enable the store media in a local storage like the system 5 ram or memory, SIM Card, Removable Flash Drive, and elements that use the USB Port, Serial Port, and others ports, 1 the hard drive in Esom's device new lock enable or dis-able 20 in the wireless media communication in WiFi, Digital compass, G4 and more, IP, Android, GPS, GMS, FM, and other satellite. Esom security apparatus or lock 8 processor (1 computer and electronic) may also guide programs 34 configured by audio video or visual pad, the 34 screen have HDTV, LCD or LED equipment, control keyboard, or touch screen, the pad 101 is equip with a touch screen lock technologies, the pad may have an antenna, (not shown). Esom's security apparatus is capable or comparable of other wireless media connection like WiFi, G network like G1, G2, G3, G4, and more, Web Cam, Skype, GPS, Android, GMS, FM, other fast satellite technologies, Esom's security apparatus may support the new and improve smart HDTV, computer and electronic equipment.

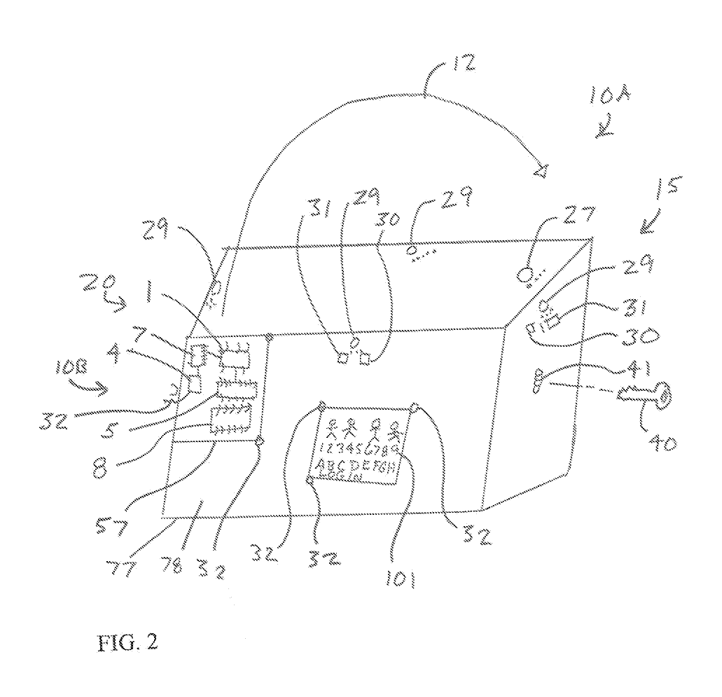

FIG. 2. This show another type of the invention, 77 it is a pad locking 12 and or combination locking technological device, 10A the locking system jam 12 for closure with 12 male and female 27 parts engage in a locking position for use.

The locking position can be unlock using 40 male and unlocking position 41. The new locking device may be remote control, 10B, 78 the new door, gate and window, or garage locking technological device, 20 may be equipped with motion sensor.

Motion detector 30. Cameras 29 and light 31, the improved locking technology device may be 20 capable of taken images, picture, voice and or video. 20 the media may be communicated wired or wireless to a receiver in another secured location or local storage. The new locking technology device may be a 77 pad lock and or a 78 combination locking types. 57 The columns case the operating system (101 computer or electronics or other devices) may be inbuilt and the lid 32 joint or separately coupled into the 15 body. 32 Coupling may include this methods rivet, wilding, screw, sapped, thermo, magnet, liquid seal, bracket, wild, Velcro, number or electronic locking.

Esom's security apparatus installed very home lock door as mention above may have upgrade technology and may be configured to better serve the owner, a powerful 8 processor (1 hard drive). The 8 processor perform high valuable job, 8 the processor receive, interpret, direct the message to appropriate receivers), before than 29 the media (34 voice, audio, video, and photo operated by keyboard or other means) is captured by auto configured, 29 camera, 31 flash, and 30 laser guide sensor and or night vision equipment. The 29 camera is configured to respond to the reaction of 30 the very sensitive 29 camera equipment. Once all the information is feed into the 8 processor, the processor determine the danger or damage, or accident, break in the vehicle. The 8 processor will transmit 9 the media 7 the language(s) to the receivers like cell phone, e-mail, printer, Facebook, Twitter, taxi insurance company, police etc. 2 the fan system cool the 4 power (AC, DC, or Solar), the refreshed energy enable configured media in wired and or wireless. The 8 processor or 1 hard ware can enable the store media in a local storage like the system 5 ram or memory, SIM Card, Removable Flash Drive, and elements that use the USB Port, Serial Port, and others ports. Esom's device, 20 in the wireless device is capable of WiFi, Digital compass, G4 and more, IP, Android, GPS, GMS, FM, and other satellite. Esom apparatus is also guide programmed 34, or configured by audio video or visual pad, the 34 screen have LCD or LED equipment, control keyboard, or touch screen, the pad 101 is equip with a touch screen lock technologies, the pad may have an antenna, (not shown). Esom's smart security apparatus or lock is capable or comparable to other wireless media connection like WiFi, G network like G1, G2, G3, G4, and more, Web Cam, Skype, GPS, Android, GMS, FM, other fast satellite technologies, Esom's security apparatus may support the new and improve smart HDTV, computer and electronic equipment.

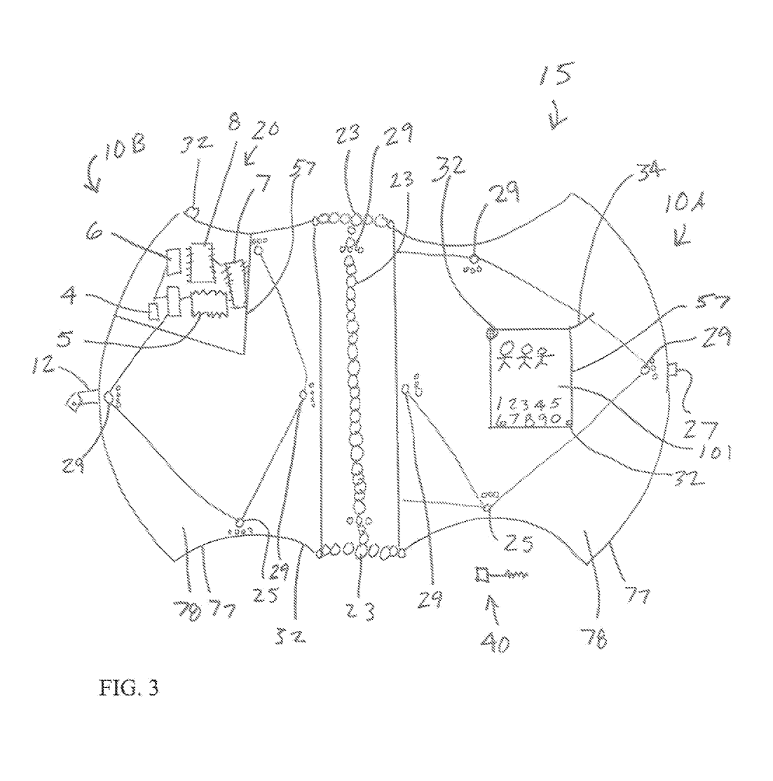

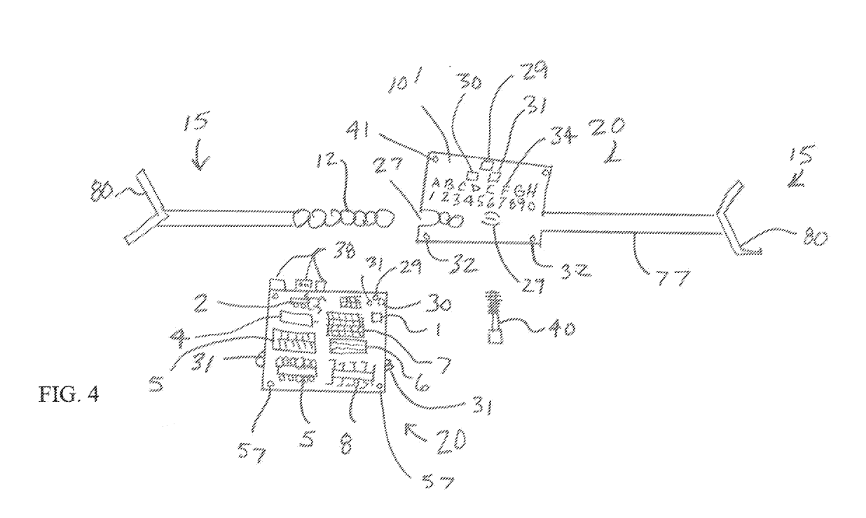

FIG. 3, and FIG. 4, 15 the invention, show another type of locking 10A technology or 10B device, 15 the device, 77 a vehicle sterling (steering) lock, the device is applied directly to sterling of a mobile vehicle and lock into the steering to restrict the moving of the steering, to avoid stolen. 20 May be made with metal and aluminum, or other strong products may be in combination of rubber, plastic, silicon or jell products. Physical shapes, sizes may continue to change to allow 101 computer and electronics devices, (not shown).

Continue with FIG. 3, and FIG. 4, 10A the (female/male) new invention may be capable of 29 camera, voices, and image captured, stored or send media to a secured receiver, WiFi, E-mail, Facebook, Twitter, etc. the 10A the device can be 27 manual or electronic operated. 22 At the edges is the handles while operating 23 adjusting the device, the handle 22 help to secure the device when the technology is not inbuilt into the steering. FIG. 3 and FIG. 4 May be inbuilt into the 77 sterling of a vehicle (not shown). This is locking technology in a cutting edge, being in contact with your property every second or at will, your property can reach or report issue to you.

Still on FIG. 3, the 10B new steer-neck locking technology or and device, may be equip with soft wear 20, the new 101 technology control 1 device driver 8 may be located 15 in the male section, 30 the new 77 vehicle locking steering-neck device may be equipped with motion detector or sensor, 31 light and alarm. Voice and video 29, image capture capability, 12 the new device can be electronically and manually operated. 27 the sterling may be locked by means 40 of a key or a number combination or 57 HDTV screen, LCD PAD or screen code locking device (HDTV LED).

This type of the new locking technology or device 23 flex to size 80 the sterling top to a rigid and suitable locking position to the vehicles, trucks, boats, plains, and or bikes. 10B the locking technology device strongly lock the physical part of the vehicle steering wheel control, the new technology may be equipped with 20 remote electronic control device, 80 the vehicle steering hooking device may have electronic, motorized or robotic control gripping (not shown). Added a special application linking to enable or disable include power, engine, view, glasses etc.

57 the columns of the locking system may case the operating system (computer or electronics or other devices) the operating devices may be inbuilt into the male or female lock parts and pug and play and a lid 32 joint or separately couple the device into the 15 body of the lock. 32 Coupling may include this methods rivet, wilding, screw, sapped, thermo, magnet, liquid seal, bracket, wild, Velcro, number or electronic locking.

Esom's security solve the difficulty of occupant guideline all entry points to the house, the new lock may have upgrade of this technologies or all of this technologies and or may be configured to better serve the occupant, any alternative configuration of a powerful 8 processor (1 hard drive). The 8 processor perform high valuable job, 8 the processor receive, interpret, direct the message to appropriate receiver(s), before than 29 the media (34 voice, audio, video, and photo operated by keyboard or other means) is captured by auto configured, 29 camera, 31 Hash, and 30 laser guide sensor and or night vision equipment. The 29 camera is configured to respond to the reaction of 30 the very sensitive 29 camera equipment. Once all the information is feed into the 8 processor, the processor determine the danger or damage, or accident, break in the vehicle. The 8 processor will transmit 9 the media 7 the language (s) to the receivers like cell phone, e-mail, printer, Facebook, Twitter, taxi insurance company, police etc. 2 The fan system cool the 4 power (AC, DC, or Solar), the refreshed energy enable configured media in wired and or wireless. The 8 processor or 1 hardware can enable the store media in a local storage like the system 5 ram or memory, SIM Card, Removable Flash Drive, and elements that use the USB Port, Serial Port, and others ports. Esom's device, 20 in the wireless device is capable of WiFi, Digital compass, G4 and more, IP, Android, GPS, GMS, FM, and other satellite. Esom apparatus is also guide programmed 34, or configured by audio video or visual pad, the 34 screen have LCD or LED equipment, control keyboard, or touch screen, the pad 101 is equip with a touch screen lock technologies, the pad may have an antenna, (not shown). Esom's new smart security apparatus is capable, comparable of other wireless media connection like WiFi, G network like G1, G2, G3, G4, and more, Web Cam, Skype, GPS, Android, GMS, FM, other fast satellite technologies, Esom's security apparatus may support the new and improve smart HDTV, computer and electronic equipment.

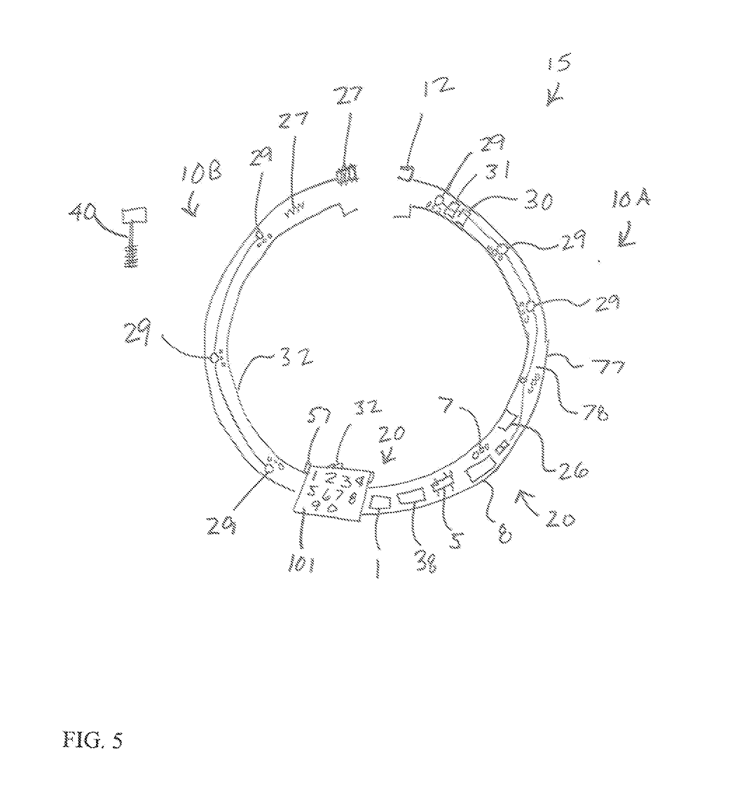

FIG. 4, and FIG. 515 this another type of locking device technology, FIG. 4, as shown the 12 device have two joinable 77 parts, each joinable 80 end placed on each side of the steering (not shown), then 77 join the 12 two as a unit before securing the device on the steering and on/off the system with touch button, or touch screen, remote control or other locking device main frame recognized. While FIG. 5, Coil around the steering, 77 the new locking 78 technology have axially locking joinable position, vertical joinable locking position and horizontal joinable locking position, one size fit all, 27 joining the body 10A for restricting movement of the (locking) car steering 10B technology, the 77 new car steering lock, or vehicle locking technology is 20 equipped with device that communicate with other media 101 electronics and computers, and it begin with motion detector and sensors, 30 the motion sensor(s) would set on/off the 29 camera(s) to begin sapping and 9 transmit the voice, video images to an in built chips, 6 server, electronic, PC and 9 transmit images 8 to any receiver HDTV, Cell Phone, e-mail, text, Facebook address, and police, and other secured storages.

The operating system (computer or electronics or other devices) may be inbuilt into the steering 57 skeleton, and column, and the lid 32 joint or separate from the steering lock, may coupled the operating system into the lock 15 body. Coupling may include this methods 77 wilding, screw, sapped, thermo, magnet, liquid seal, bracket, wild, Velcro, number or electronic locking, user ID, password, code, scan card and 40 key locking methods, 57 plate, 32 a plate lid, shapes, and sizes may change to allow 101 computer and electronics devices (not shown), the same applied to FIG. 1 to FIG. 17. The new steering locking technology application be configured to enable or disable the engine, glass, etc if stolen.

Continue in FIG. 4. 30 the locking technology rest on the steering and remain 41 locked 27 to the steeling, until unlocked by 40 a key, remote control, number combination. Alternatively may be operated or unlock by electronic, and computer, manual device (not shown). 57 columns the operating system (computer or electronics or other devices) may be inbuilt into the door skeleton and or independent, the Hd 32 joint or separately coupled into the 15 door skeleton. 32 Coupling may include this methods rivet, screw, sapped, magnet, liquid seal, bracket, wild, Velcro, number or electronic locking. FIG. 5. 15 may be used by it self or in combination of the neck steering locking system (seen in FIG. 3) and may be configured to be use or configured to combine the steering locking technology (configured to combine the function of FIG. 4, or FIG. 5, not shown). Again a boot may be design for the gas paddle, break paddle or crunch (not shown).

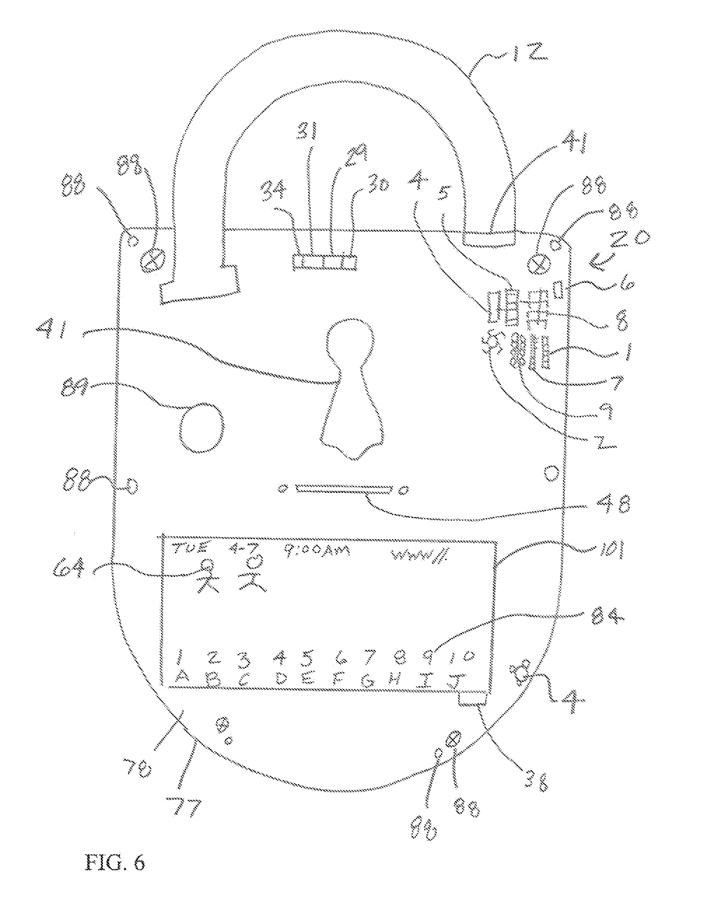

FIG. 6, 15 Esom security apparatus and application solve the security challenges of access, egress, and other emergency in a house by providing new, smart, and simple upgrade locking technologies that enable the occupant, of a home to view, read, write, or perform all security access of the occupant premises in minutes or ahead of emergency or program the locking technology to assume control if the occupant is unable to make a decision. The new lock all in one technology can service the occupant security need by wired or wireless technology affordably and reliably. All in one means configuration, combination or comparable or functional unification of all media information form camera system, lap top, motor, computer, iPad, electronics, HDTV, Key Lock, Combination Lock, Front Lock, Back Lock, Dead Bold, Bolt lock, Latch, Lock Hand, Door etc. into one source in a house hold.

FIG. 6, provide an independent and advance door, gate, son-roof, window with 30 motion detector, 29 a high performance HD camera and performance security light and or 34 alarm. This high quality 29 camera equipment is connected a (computer and electronic) 1 hard drive or high performance 8 processor, a durable 6 server, the 8 processor receive the media from the 29 camera, the 6 server, or the 9 transmitter distribute the media to local storage or 5 memory, to export the media to a receiver out the local net work, or wireless receivers with programmed code. The language 7 part of the system is located between the 9 transmitter and the 1 hard.

FIG. 6, future a manual locking operating systems, the lock key may be equipped with the computer and or electronics as may be recognized, communication with the main system as seen in FIG. 6, the 12 male part, while demonstrating 41 the female locking part in manual locking.

Continue with FIG. 6, the new locking technology is equipped with HDTV, the new locking system have number locking system only accessible by provide touch screen, the HDTV enable visual communication and all 88 other audio video communication between authority and the 64 occupant, or burglar, the HDTV is equipped with serial port, etc. for communication with other computer and electronics.

Continue in FIG. 6. 15 The automatic, or the robotic set of the new lock technology are generally 77 located in the back set of the new door, locking technology, it operate with a set command from, the occupant of the house, a sensor type operative system may be programmed to detect by visual, laser or encoded technology, a person or objects unauthorized or authorized movement or entering into the premise, 8 the door will 15 enable it self according to 1 it program, example open or close, (the door with, signal, voice, punch button, any command or alert situations) (not shown).

Continue in FIG. 6. 15 the difficult of an occupant of a home is made easy and safer by Esom security apparatus, the new locking technology combo of motorized, computer and electronics driven automatic lock equipment, the 77 back set of the locking device may be equip with tracks, axel or channels for movement of the new lock multi system or single lock, example deadbolt, latch, etc. (not shown). The activities of the motor door, locking device may be enhanced in delivering access, egress or other emergencies 1 with a visual, voice, read, write, data 7 and information communication provide by in built computer or electronic system or laser guided independent 8, 5 other independent connect door, 1 lock 30 systems 31 in the 29 premises, or any 101 other method of configuration in the home locking 41 door technology 408.

FIG. 6. 20 Esom's security apparatus installed new home lock door as mention above may be upgraded of this technologies or all of this technologies and may be configured to better serve the occupant of the home, a powerful 8 processor (1 hard drive). The 8 processor perform high valuable job, 8 the processor receive, interpret, direct the message to appropriate receiver(s), before than 29 the media (34 voice, audio, video, and photo operated by keyboard or other means) is captured by auto configured, 29 camera, 3I flash, and 30 laser guide sensor and or night vision equipment. The 29 camera is configured to respond to the reaction of 30 the very sensitive 29 camera equipment. Once all the information is feed into the 8 processor, the processor determine the danger or damage, or accident, break in the vehicle. The 8 processor will transmit 9 the media 7 the language(s) to the receivers like cell phone, e-mail, printer, Facebook, Twitter, taxi insurance company, police etc. 2 the fan system cool the 4 power (AC, DC, or Solar), the refreshed energy enable configured media in wired and or wireless. The 8 processor or 1 hard ware can enable the store media in a local storage like the system 5 ram or memory, SIM Card, Removable Flash Drive, and elements that use the USB Port, Serial Port, and others ports. Esom's device, 20 in the wireless device is capable of WiFi, Digital compass, G4 and more, IP, Android, GPS, GMS, FM, and other satellite. Esom apparatus is also guide programmed 34, or configured by audio video or visual pad, the 34 screen have LCD or LED equipment, control keyboard, or touch screen, the pad 101 is equip with, a touch screen lock technologies, the pad may have an antenna, (not shown). Esom's security apparatus is capable or comparable to other wireless media connection like WiFi, G network like G1, G2, G3, G4, and more, Web Cam, Skype, GPS, Android, GMS, FM, other fast satellite technologies, Esom's security apparatus may support the new and improve smart HDTV, computer and electronic equipment.

FIG. 7, 15 A new locking device technology for a vehicle doors or boot, or trunk, roof door, home door, window, gate and garage, 77 the device may be independent or inbuilt (78 assembled mechanical) into the car or home's door, 15 the body column, or skeleton of the car door locking device, 15 this type of locking device is installed inside the Column of the door and 32 clip or coupled into the 15 body by a 32 lid rivet, screw, thermo, and 57 other mechanical coupling of device onto the inside door locking system, making the operating device plug and play (not shown).

The end equip with 40 the opening key and 29 the motion detector, camera, and speaker facing the outside body part of the car door or street side of the door (not shown). To educate the intruder an HDTV, LCD or LED screen may be inbuilt or attach, to the doors, trunk, front, or roof, and showing the intruder and the new lock door application can successfully report, dial, e-mail captured media (accessible or 20) call to owner, police, e-mail, SIM Card, Facebook, Twitter via WiFi. Cutting edge technology to the locking device.

FIG. 7 Continue, 10A the installation completed 10B, the new locking device 40 technology opens and 15 close car through the 41 door keys. This FIG. 7 have the new technology that communicate information with the inbuilt chips and motion detector, 29 to establish the present of an intruder, 20 the device would warn, voice, picture, video, alarm to protect and help apprehend.

Continue in FIG. 7, the car new door and trunk locking device may be equip with electronic device that may be protected and enclose with a plastic or glass and activated by a remote control. The device may be switched to a 24 hours 31 motion 31 detector mode, 29 the camera is capable of rotating or equip with sensor that detect and follow the image(s). And the camera, sensor, alarm, computer, or electronic may be installed inside and outside the door area of the vehicle.

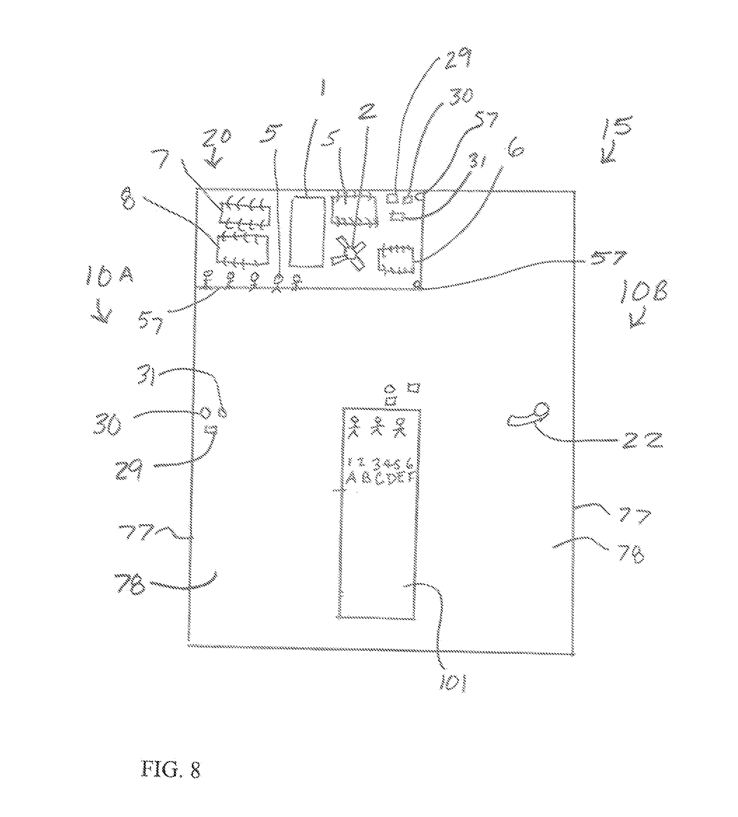

Illustrated in FIG. 8, 10A a 77 door (front, back, or rooms) 10B with a 20 computer main frame at the top is the operating system of the invention, the operation system of the invention may be a box inside the 78 column of the door far from: visibility of the naked eyes, unless a glass door, transparent, translucent material, the 4 power supply switch on or off of the computer operation. The 1 hard drive command deeply the operating system, the 1 hard drive synchronize all the programming or processing path, and hard drive 1 is the main storage for the system for the invention. 8 The processor runs the operative as it is captured from the 30 laser command camera 29 voice, video, and picture. 8 the processor retrieve information 5 memory and 1 hard drive. 9 the transmitter circulate, refresh the system that carry the media. 7 the mail attachment supply, support the 20 computer and electronic programs and support for multiple languages, and characters simultaneously, transfer media into PDF, JPG, TIFF, GIF Images, Adobe, PPTX, HTML, (WEB, WiFi) HTM, PC Window 7, Window Vista, Window XP, Camera, etc.

Continuing in FIG. 8, 29 Camera (media) are a high 29 powered lens, capability of 30 photos, video, alarm, 34 audio and visual, 29 the camera is 30 auto focus, audio playback and volume. The 29 camera is guided by 31 laser, the sensor and powerful 31 laser have a long rang impulse or captured movements loaded with 30 powerful flash(s). This system works with android, GPS, Smart HDTV, Electronic, 5G technology and more, GPS, GMC, wired or unwired, this operating system can be install or attached to doors, windows, cabinet doors, on the ground lifting doors, wall, other home equipment. 15 Esom security apparatus illustrate 22 the handle and or lock device (see FIG. 7).

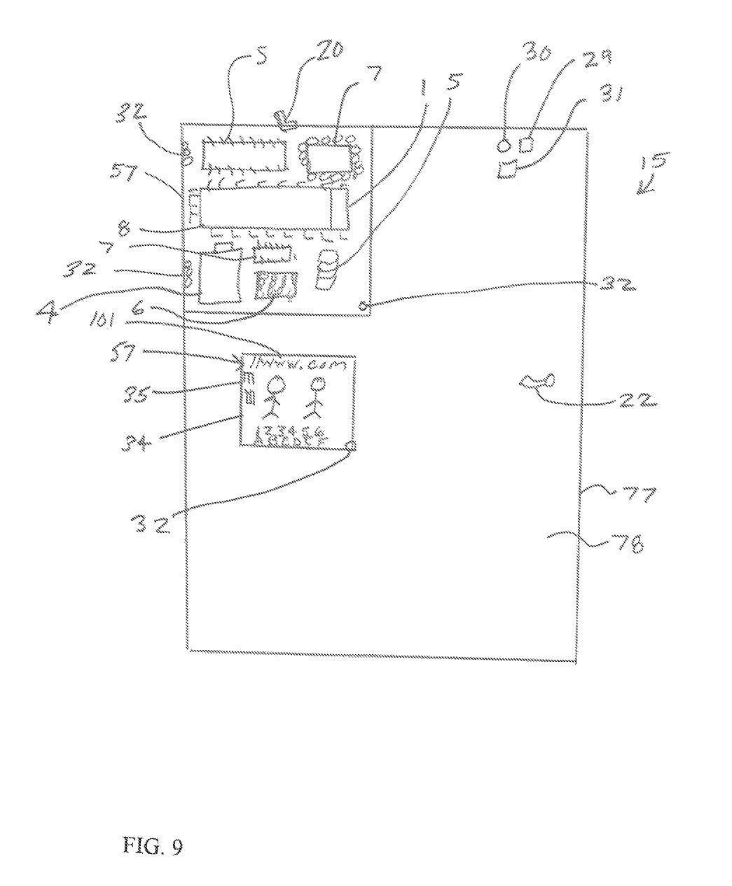

FIG. 9 Illustrate is another type of the invention a home, 77 gate, garage, door. As 15 illustrated the door, gate, or garage may be 22 locked or unlocked, (See FIG. 2) and (See FIG. 7). The operating system may be with or without a full computer PC system. The system is powered by a switch, the on and off button control by 4 powered battery, solar, AC/DC. The control of the invention is a powerful 8 processor, or hard drive, the 20 processor digest the communication using the enhanced 7 mail attachment support or language support system (excel, window 7, window XP, PDF, JPG, TIFF, Image, Adobe, PPT, PPFX, HTM-WEB, PC other resolutions, this system is operate with a powerful and enhanced 5 memory. The 30 laser is enhanced by a powerful sensor(s), the 30 laser sensor activities the 29 camera's command, as may be configured by the owner. The 29 camera with 31 flash light receive or captured media, transfer the captured media to the 78 inventor processor which interpret the communication and release the media through wired or wireless 6 server, WiFi, communication to outside storages and include personal cell phones, e-mail, Facebook, Twitter, police, captured hi invention glowing HDTV, LCD screens, LED, energy saving mode, include operating systems or soft like screen keyboard, and screen lock system, touch screen, password, user ID, code, and scanner, etc. may be 1 a hard, drive may be used. 57 columns the operating system (computer or electronics or other devices) may be inbuilt and the lid 32 joint or separate coupled into the 15 body, column, or skeleton of the door. 32 Coupling may include this methods rivet, screw, sapped, magnet, liquid seal, bracket, wild, Velcro, number or electronic locking. 57 The LCD (LED) screens or pad may be equipped with water-proof, shock-proof and freeze-proof material(s).

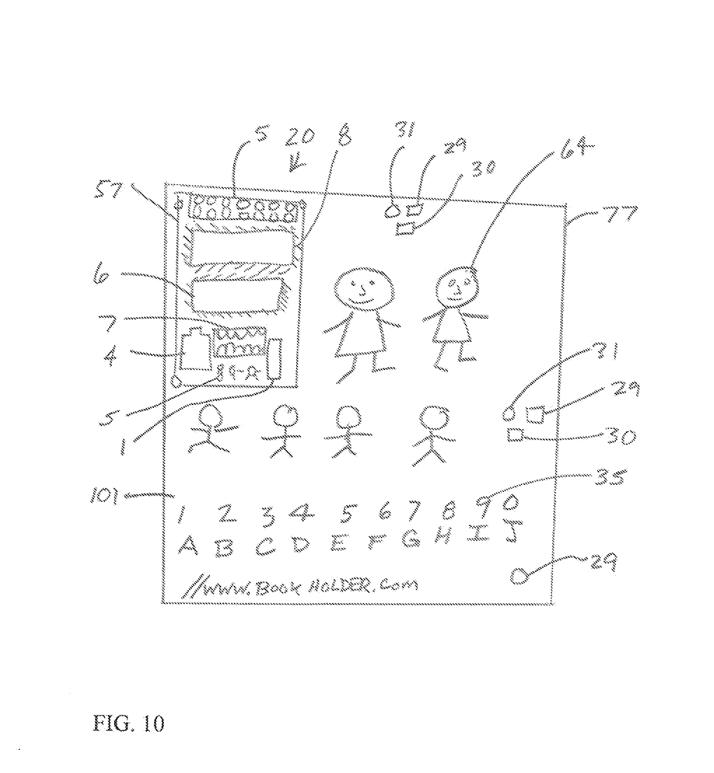

FIG. 10. 20 illustrate a vehicle version of the invention 101 a screen pad, HDTV (Audio Video) an Esom security system car version can be 77 installed rivet, screwed or other mechanical configuration to the car handle, door, glass, dash board, it may be over any shape and size not shown) or attach interior and exterior to provide security to the 55 car and 64 owner of the car or vehicle. The operating system may be controlled by a high 8 powered processor, the 8 processor receive media (34 voice, audio, video and photo) 2.9 captured by the camera unit which include 30 a powerful 30 laser and flash 31, if the treat is not distortive the effective media capture may be stored in 5 the memory or removable storage. The 20 the media may 9 transfer the captured treat to the 55 vehicle to outside the 55 vehicle, alarm the owner or the authorities by 7 alarm, voice, 34 photo, audio and video 29 telecast to cell phone, e-mail, Facebook, Twitter, and other wired and wireless, serial ports communication to other electronics and computer, phone. 10 the lower portion of the invention may be 34 the operating and configured keyboard or other software. The invention can be made in many shapes and sizes, and it could be soft transparent material or hard and soft transparent or translucent materials. Esom new smart security apparatus is capable or comparable to wireless connection, and communicate media like WiFi, G network, G1, G2, G3, G4, G5, MIG 3 and so on, GPS, Android, GMS, FM and other fast satellite technology, the invention may get support from new and improve smart HD, HDTV, independent camera, computers, and electronic. 57 columns the operating system (computer or electronics or other devices) may be inbuilt and the lid 32 joint or separate coupled into the 77 body. 32 Coupling may include this methods screw, sapped, magnet, liquid seal, bracket, wild, Velcro, number or electronic locking. FIG. 10. 101 portable HDTV, or screen (Audio Video) pad may be used in a home, or apartment building.

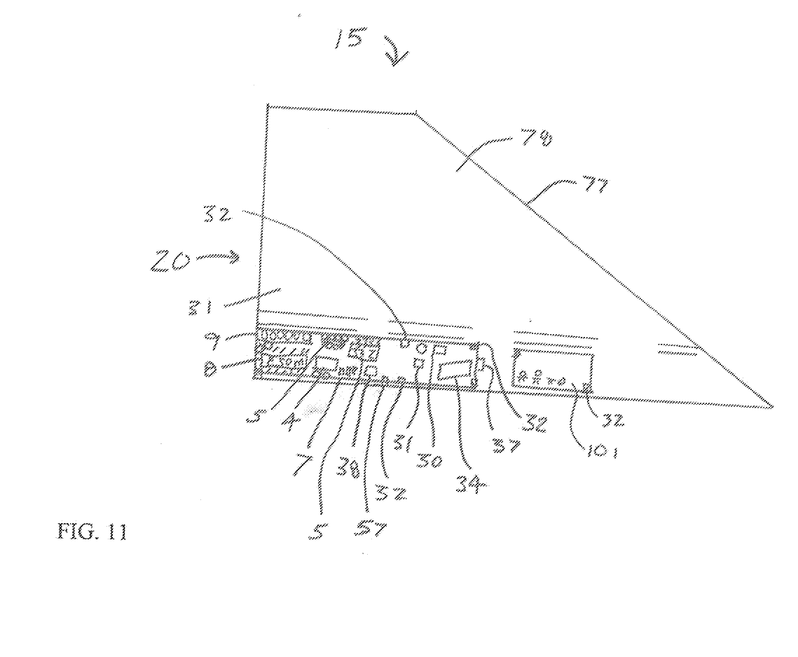

FIG. 11. 15 Illustrate 77 Esom security apparatus (invention) for 55 vehicle door or any part there off in a 55 truck(s), 78 the installation of Esom security apparatus 77 in car doors may change the shape, and size, materials to make car doors or vehicle is well document in this passage. 20, the energy that 4 powered the apparatus may be AC, DC, solar or car battery, it energize and refresh (wire) the high powered 8 the processor (may have hard drive). The 8 processor perform high valuable job, 8 the processor received, interpret and direct the message to appropriate receiver(s), before than 29 the media (34 voice, audio, video and alarm, photo and Hashing light) is captured by auto configured or independent coded smart camera and 31 flash, 29 the camera is configured to respond to the action of 30 the very sensitive laser(s), once all the information is feed into the 8 processor, the 8 processor determine the danger or damage, or accident to the vehicle. The 8 processor will transmit (to a sever 9) the media 7 language(s), the receiver need like cell phone, e-mail, printer, Facebook, Twitter, insurance company, police etc. communication could be configured to carry media in wired or wireless. The 8 processor can also store media in a local storage like 5 the system (Ram) memory, SIM card, removable flash and elements that use 38 USB, in the wireless the device is capable of WiFi, Digital compass, G5 and more, IP, Android, GPS, GMS, FM and other satellite, Esom Apparatus is also guide or programmed 34 or configured by a pad, the 34 pad have LCD screen and control buttons, the pad is equipped with a touch screen lock technology, the pad may have an antenna (not shown). 57 columns the operating system (computer or electronics or other devices) may be inbuilt and the lid 32 joint or separate coupled into the 15 body. 32 The LCD PAD (LED HDTV) Coupling may include this methods screw, sapped, magnet, liquid seal, bracket, wild, Velcro, number or electronic locking. The 32 LCD PAD (LED HDTV) may sometimes coupled over 57 the operating systems 1 CPU, 29 camera, motion 30 laser detector and 31 light.

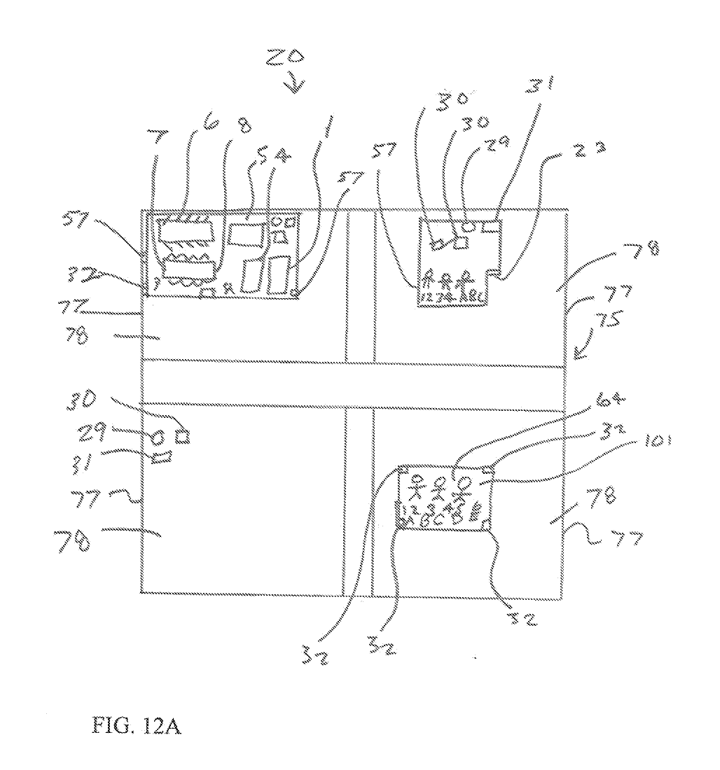

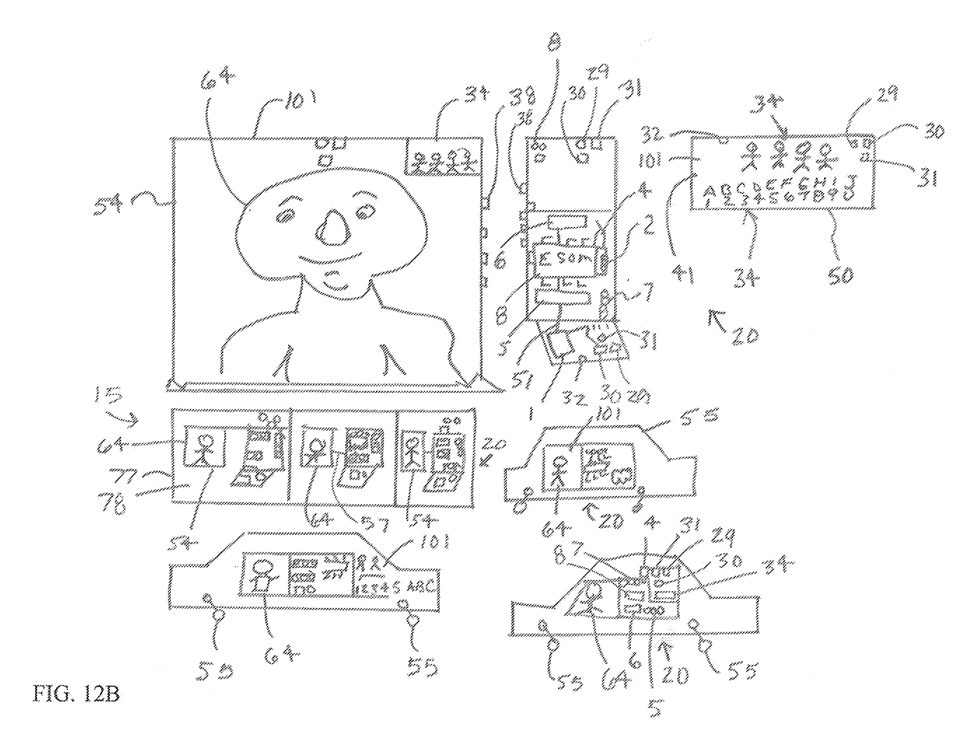

FIG. 12. 15. As illustrated 77 a home in Esom apparatus, FIG. 12, 20 the technological devices 101 that power Esom's security apparatus as illustrated, in 78 the body or skeleton are door, window, garage, all other entrances to the 77 home, 20 device, 55 car, and 64 owner in a multi-media communication, or exchange, 78 inside the column of the door skeleton might be 20 installed the computer PC or simo, server, electronic, etc. Now to the technology that power Esom security 101 pad screen or HDTV (audio video) in a home door skeleton, and vehicle, FIG. 12. the upper level of the pad illustrate a powerful 29 camera, guided by 30 a sensitive laser, and light the upper level of the pad may be capable of digitized telecasting 34 the communications of media (34 video, voice, photo, alarm, and LCD screen PAD) to other carriers like 54 cell phone, HDTV, 101 computer, iPad and electronics.

FIG. 32 continued, The device have 20 operating system at the lower 20 part of the device pad, the battery, solar, AC/DC energy and power that refresh all the other devices, 7 the lower section have mail support device like PDF, JPG, TIFF, GIF, other resolutions, Adobe, acrobat, PPT, PDFX, HTM (web), HTM PC Window, Window Vista, Window XP, WiFi, G4, G5, (full manual or remote control, cell phone remote control) and 7 all language support, may be equip with 57 panic or emergency voice, button, or touch screen command. The command 8 center for Esom security apparatus is the large and sensitive processor, 8 the processor is the media exchange, (1 hard drive) and communication, for 77 home (55 vehicle) protection, wired or wireless communication device get their command 8 from the processor, including 30 detect motion, 31 flash, and 29 camera configured at the door or window, gate, garage, lifting exits for system automatically dialing, motion activated day or night, 51 connect directly to your HDTV for viewing any disturbance wired or wireless at your premises, and other belongings any where without additional fee charged.

Continuing with FIG. 12. Side the up side of the invention 38 is the connecting ports 54 other media supportive devices like computers, 38 USB port, electronics, cell phone, HDTV, iPad, phone, printer, FM radio, games, police, insurance company, SIM card and other removable memory etc. 10B, on the lower side of the invention there 5 is enhanced memory with a big storage capability, in communication 6 is the system server. As 20 illustrated in FIG. 12. In 10B the lower side of the invention 41 may be a lid to cover the operating system, the lid 20 cloud be lock with key and or screen code or other methods. The 41 lid may be 1 equipped with a command system, 1 the hard drive, 29 extra camera, 31 flash and a 30 very sensitivity and powered laser detector(s).

Continuing with FIG. 12. The 57 pad may be programmed or deprogrammed to answer door, direct a repair person with an assigned scannable code to enter and exist from a point, time, scanning and log-off, the 34 dialogue box could be manual or remotely control media exchange, money exchange and payment of receipt may be transited between landlord and persons of interest at the home door skeleton electronic and computer equipment. 50 the command may be touch screen or manual or remote or cell phone remote command. The 34 screen could be removable or plug and operational system, the 34 screen could be locked with a 41 key or lock with a security code, password, user ID. To assemble the 34 screen on the operating system permanently or plug and program, 50 the screen may be rivet, screwed, or other mechanism to configure it 32 into the 20 body skeleton, or 57 other fastener like magnet, clips, and snap methods. 101 the screen may be programmed to command 20 with the systems operation to communicate with any receiver(s) in 77 the house, or 55 in a vehicle or plane or boat. The 20 system can brief 64 the owner on condition in his 55 vehicle as he leaves 77 office, and conditions at 77 home before he arrived from work.

Continue with FIG. 12. Esom security apparatus 77 illustrated a building, home, or living space, 77 the apartment is 20 installed with Esom's security apparatus, 64 the owner of the 78 building can access information or communicate from any 55 receiver like vehicle 20 configured in dialing, or code communication, and may remotely (wired or wireless) transmit or receive media, get automated information alert or alarm, 20 the device, 50 if programmed in timer can automatically alert or alarm the authority, e-mail, Twitter, online, save information in private storage system, Esom's security apparatus may communicate to other receiver in 34 voice, video, picture in a second of a time. Including detecting carbon monoxide, carbon dioxide and fire in a home and vehicles.

Continuing with FIG. 12. 20 Esom's security apparatus, referring to 55 vehicle installed with the device, the 55 vehicle's 64 owner may communicate and 34 receive voice, video and picture of his/her office from the 55 vehicle before he/she step into the office space. Protection and education, alert advisory start from the front gate or court yard gate or yard gate before intruder enters the apartment, house, building or vehicle door. To be clear, Esom's security apparatus may be inbuilt or installed with heavy tools or attached into the structure, subtracts, components in a vehicle, or a house, method of installation may be inside or outside the subtract, or the components of the 55 vehicle, where ever the owner of the Esom apparatus find resourceful.

Esom security apparatus (computer, and electronic) can be linked to a Government site for advisory like purchasing 55 may be a scannable parking lot ticket or locating parking, upcoming events, repairs and other changes in town, diary personal and or official, call help, live HDTV, E-Book, Radio, phone, internet cell phone, or phone.

Base, columns the operating system (101 computer or electronics or other devices) may be inbuilt and the lid, base 32 joint or separate coupled into the 15 body. 32 Coupling may include this methods screw, sapped, magnet, liquid seal, bracket, wild, Velcro, number or and electronic locking.

FIG. 12 Continued, illustrate Esom's security apparatus for exterior, or interior (gates, pliers, wall, windows, 77 home, 77 building, 55 mobile vehicle.

Esom's security apparatus installed new home lock door as mention above may be upgraded with this technologies or all of this technologies and may be configured to better serve the occupant and affordable to the occupant, a powerful 8 processor (1 hard drive). The 8 processor perform high valuable job, 8 the processor receive, interpret, direct the message to appropriate receiver(s), before than 29 the media (34 voice, audio, video, and photo operated by keyboard or oilier means) is captured by auto configured, 29 camera, 31 flash, and 30 laser guide sensor and or night vision equipment. The 29 camera is configured to respond to the reaction of 30 the very sensitive 29 camera equipment. Once all the information is feed into the 8 processor, the processor determine the danger or damage, or accident, break in the vehicle. The 8 processor will transmit 9 the media 7 the language(s) to the receivers like cell phone, e-mail, printer, Facebook, Twitter, taxi insurance company, police etc. 2 the fan system cool the 4 power (AC, DC, or Solar), the refreshed energy enable configured media in wired and or wireless. The 8 processor or 1 hard ware can enable the store media in a local storage like the system 5 ram or memory, SIM Card, Removable Flash Drive, and elements that use the USB Port, Serial Port, and others ports. Esom's device, 20 in the wireless device is capable of WiFi, Digital compass, G4 and more, IP, Android, GPS, GMS, FM, and other satellite. Esom apparatus is also guide programmed 34, or configured by audio video or visual pad, the 34 screen have LCD or LED equipment, control keyboard, or touch screen, the pad 101 is equip with a touch screen lock technologies, the pad may have an antenna, (not shown). Esom's new smart security apparatus is capable, or comparable to other wireless media connection like WiFi, G network like G1, G2, G3, G4, and more, Web Cam, Skype, GPS, Android, GMS, FM, other fast satellite technologies, Esom's security apparatus may support the new and improve smart HDTV, computer and electronic equipment.

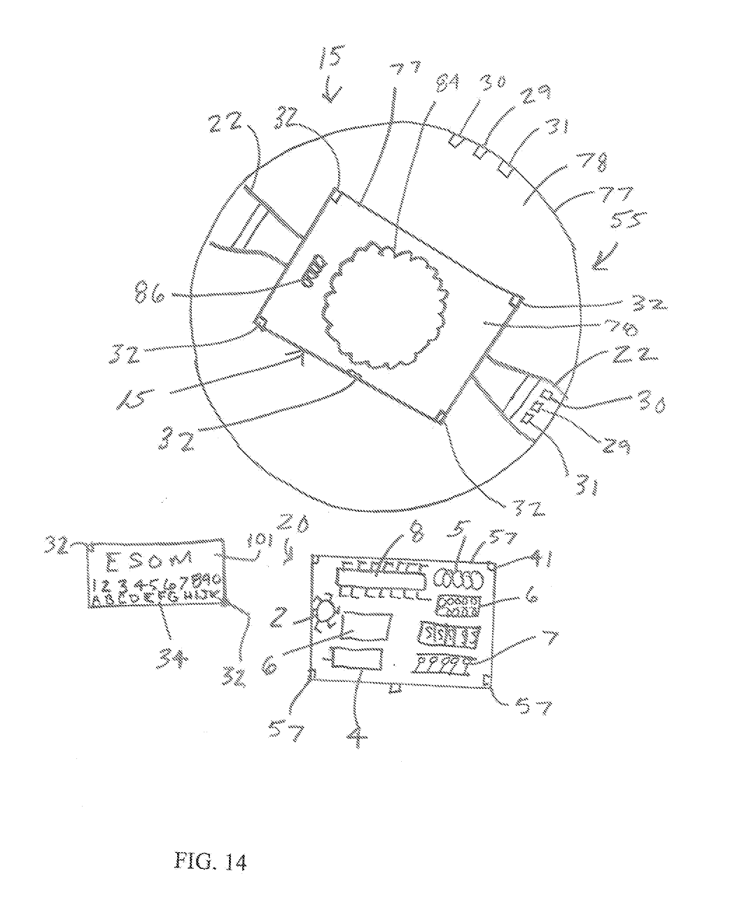

FIG. 14. 15. Demonstrate a 55 vehicle 77 steering, the control of the 55 vehicle wheels, the wheel may have control device holding between 84 the wheels and the steering, the 77 sterling may be rounded, or in other shapes and size, 22 for rotation and vehicle direction.

FIG. 14. 15 the steering 84 have an inside membrane or a 32 base for the electronic or 101 computer, 20 the smart technology is placed onto the middle of steering. The new 20 technology add more safety and security to the 55 vehicle through it steering locking system in FIG. 14, Esom security apparatus technology provide software security that may recognized any or all this print, voice, picture, card, password, user ID, to unlock, the steering may be capable of media exchange.

Like the most of Esom's security apparatus, the technology (s) may be factory inbuilt and user's 64 plug and play, or may be installed with heavy, or light tools, or attached to an 55 mobile vehicle steering. Esom's security apparatus may have all the technologies as mentioned above, and more if necessary, or some selected parts as the need is required.

The technologies may be coupled or cased in material such as metal, cooper, aluminum, wood, titanium, leather, cloth, plastic, rubber, weather (water) resistance materials, and foam. 57 The 10.1 LCD (LED) screens or pad may be equipped with 20 water-proof, shock-proof and freeze-proof material(s).

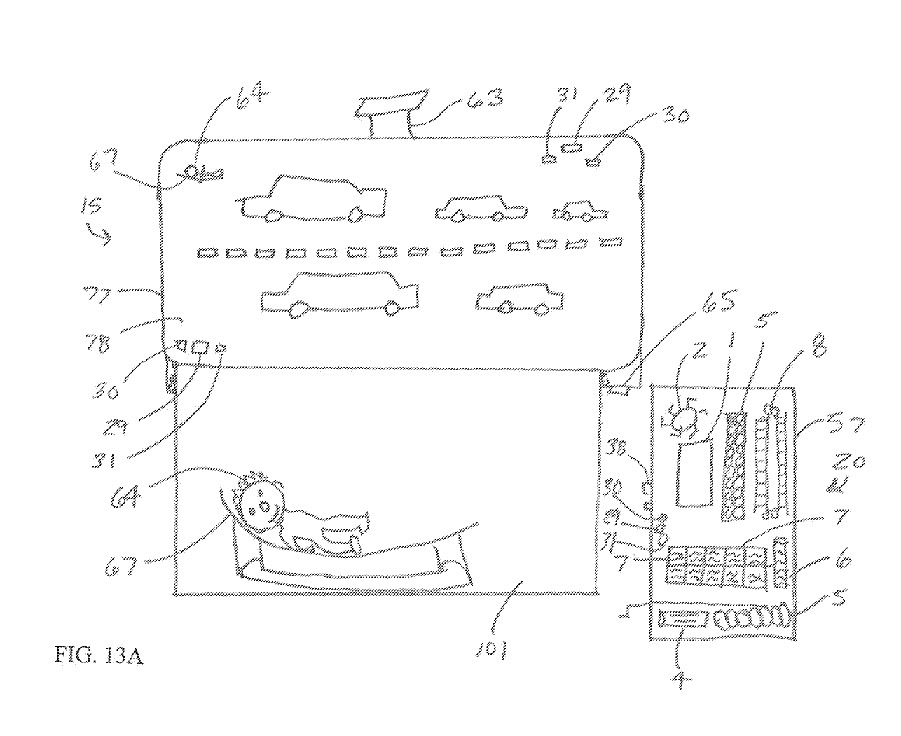

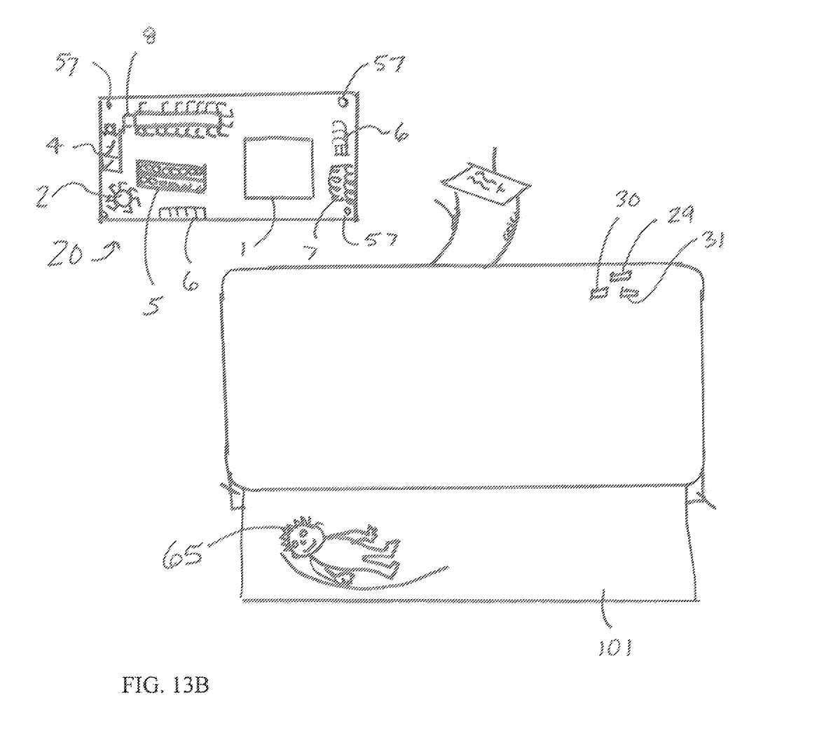

FIG. 13.15, Esom's security apparatus illustrate 77 a vehicle mirror, readily the vehicle mirror is directed to observed the traffic on the blindside of the 64 occupant of the 55 vehicle. But the new Esom's security may be capable of 101 2^{nd} screen, HDTV screen, 101 the 2^{nd} screen may be electronically 65 adjustable, horizontal, or vertical movement, 101 the 2^{nd} pad screen, and HDTV, may be programmed for a selected views interior or exterior of the vehicle, 64 for example, shown is an infant in a back sit 67 seat of a driven vehicle. The technology in the vehicle mirror (windshield, glass and front mirror) may have the capability to centralized all media views around the vehicle, home and office.

FIG. 13. 20. Esom security further illustrate the technology that enable the audio visual 78 illustrated in the 64 mirror 67 or in the 101 2^{nd} HDTV screen.

FIG. 14 Esom's security apparatus may 64 save life and reduce accident by increase awareness and visibility of driver and 55 vehicles 64 occupants (interior or exterior of the vehicle or home) 29 during motion or before motion, the camera(s) may create 34 visual, audio, voice, and photo or 34 audio communication between under age passengers and driver in which the driver remain focus on the road. FIG. 14, 20 according to the embodiment, 29 the driver receive 34 audio, visual, voice and photo communication by looking at the front mirror or glass, windshield LCD screen, projector like view, rearview reflex or connection, sides mirror reflex or visual, audio, voice, and photo connection (or 4G, server, processor, or computer connection). All safety 65 view may be centralized, 64 selected, 55 enlarged, minimized, 65 cling or recycling 101 The recycling device 20 control by a motor or electronic, 101 the cling screen may be a flip type, a pull to view type.

FIG. 13. 15 illustrated Esom's security apparatus as describe in FIG. 13 embodiment, FIG. 13. 15 describe in the 77 embodiment is a mirror or glass, (apartment, house, building or vehicle) 77 windshield 101 LCD, and TV screen, more especially vehicle mirror HDTV or glass screen or windshield audio video screen, according to Esom's security apparatus the 77 glass or mirror, or windshield LCD, or 101 TV screen may be worn 63 or attached, or inbuilt, may be a plug and play elastic attachment, attached by magnet, zip, Velcro, glue, thermo, onto or behind, inbuilt into the mirror or glass, windshield, or 101 the audio screen would act as the lid covering 20 the technology like computer PC, electronic or 20 device industrially inbuilt, 20 or the 57 cover may be customized in the shape, size and colors of the vehicle, building, or a house (window or door) glasses or mirrors.

FIG. 13. As illustrated in the embodiment 15, Esom's security apparatus may be made with one or all these materials. Materials may be metal, cooper, aluminum, wood, titanium, leather, cloth, plastic, rubber, foam, valor, button, zip, snap button, magnet, coat and, the mentioned materials) may be sworn or thermo, or other factory fabricated for vehicle, apartment, house or building, glass, plastic or mirror or may be the covers.

FIG. 13. 20 Esom's security apparatus installed new home lock door as mention above may be upgraded to this technologies or all of this technologies and may be configured to better serve the occupant and affordable, a powerful 8 processor (1 hard drive). The 8 processor perforin high valuable job, 8 the processor receive, interpret, direct the message to appropriate receivers), before than 29 the media (34 voice, audio, video, and photo operated by keyboard or other means) is captured by auto configured, 29 camera, 31 flash, and 30 laser guide sensor and or night vision equipment. The 29 camera is configured to respond to the reaction of 30 the very sensitive 29 camera equipment. Once all the information is feed into the 8 processor, the processor determine the danger or damage, or accident, break in the vehicle. The 8 processor will transmit 9 the media. 7 the language(s) to the receivers like cell phone, e-mail, printer, Facebook, Twitter, taxi insurance company, police etc. 2 the fan system cool the 4 power (AC, DC, or Solar), the refreshed energy enable configured media in wired and or wireless. The 8 processor or 1 hard ware can enable the store media in a local storage like the system 5 ram or memory, SIM Card, Removable Flash Drive, and elements that use the USB Port, Serial Port, and others ports. Esom's device, 20 in the wireless device is capable of WiFi, Digital compass, G4 and more, IP, Android, GPS, GMS, FM, and other satellite. Esom apparatus is also guide programmed 34, or configured by audio video or visual pad, the 34 screen have LCD or LED equipment, control keyboard, or touch screen, the pad 101 is equip with a touch screen lock technologies, the pad may have an antenna, (not shown). Esom's new smart security apparatus is capable or comparable to other wireless media connection like WiFi, G network like G1, G2, G3, G4, and more, Web Cam, Skype, GPS, Android, GMS, FM, other fast satellite technologies, Esom's security apparatus may support the new and improve smart HDTV, computer and electronic equipment.

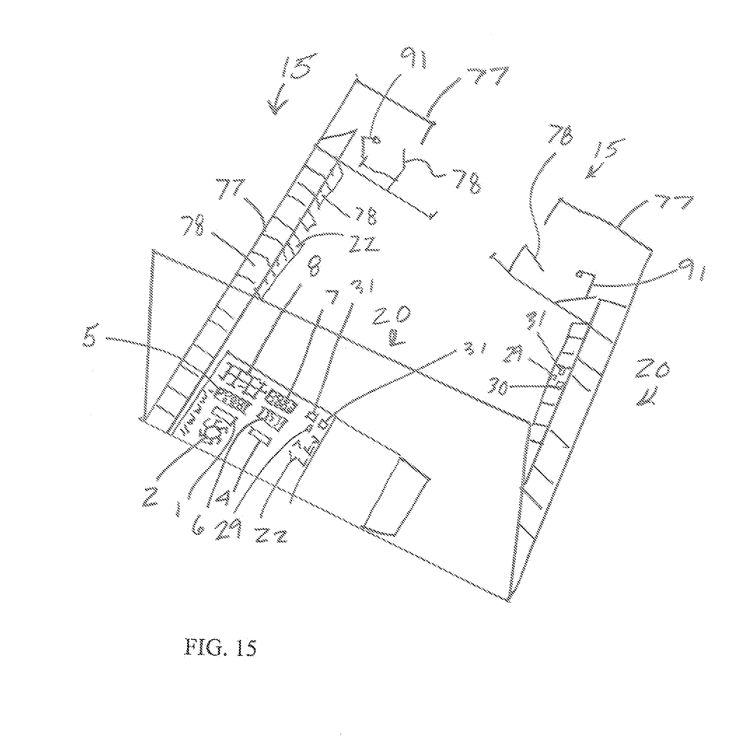

FIG. 15. 15 illustrated is an independent 77 locker gym 78 door and lock, or inbuilt locker room door lock, kitchen cabinet, or 78 a closet door and lock system. 15 According to the embodiment, Esom security apparatus illustrate an 15 excise 78 room lock technological device on the locker room door. The 78 locker door is equipped with 22 handle or a lock as mentioned above.

The technologies may be coupled or cased in metal, cooper, aluminum, wood, titanium, leather, cloth, plastic, rubber, weather (water) resistance materials, and foam. 57 The 101 LCD (LED) screens or pad may be equipped with 20 water-proof, shock-proof and freeze-proof material (s) (not shown).

FIG. 15. 20 Esom's security apparatus installed newhome lock door as mention above may be capable of upgrade technologies or all of this technologies and may be configured to better serve the occupant, a powerful 8 processor (1 hard drive). The 8 processor perform, high valuable job, 8 the processor receive, interpret, direct the message to appropriate receiver(s), before than 29 the media (34 voice, audio, video, and photo operated by keyboard, sensor, tinier, night vision or other capability) is captured by auto configured, 29 camera, 31 flash, and 30 laser guide sensor and or night vision equipment. The 29 camera is configured to respond to the reaction of 30 the very sensitive 29 camera, equipment. Once all the information is feed into the 8 processor, (I hard drive) the processor determine the danger or damage, or accident, break in, into the vehicle. The 8 processor will transmit 9 the media 7 the language(s) to other receivers like cell phone, e-mail, printer, Facebook, Twitter, mobile technology devices, insurance company devices, police devices, //www etc. 2 the fan system cool the 4 power (AC, DC, or Solar), the refreshed energy enable configured media in wired and or wireless. The 8 processor or 1 hard drive may enable the storage of media in a local storage like the system 5 ram or memory cards, SIM Card, Removable Flash Drive, and elements that use the USB Port, Serial Port, and others ports. Esom's device, 20 in the wireless device is capable of WiFi, Digital compass, G4 and more, IP, Android, GPS, GMS, FM, and other satellite communication exchange devices. Esom apparatus may be capable of other computer guide programmed 34, or configured by audio video or visual pad, the 34 screen may have HDTV, LCD or LED equipment, control keyboard, or touch screen, the pad 101 is equip with a touch screen lock technologies, the pad may have an antenna, (not shown). Esom's new smart security apparatus is capable or comparable to other wireless media exchange or connection like WiFi, G network like G1, G2, G3, G4, and more, Web Cam, Skype, GPS, Android, GMS, FM, other fast satellite technologies, Esom's security apparatus may support the new and improve smart HDTV, computer and electronic equipment.

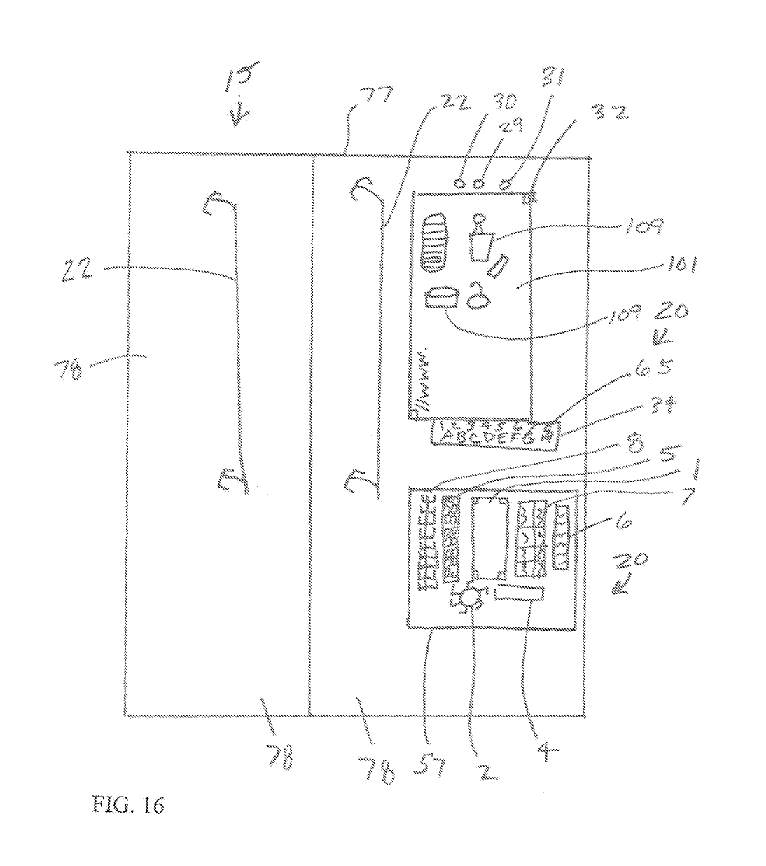

FIG. 16. and FIG. 1.7, demonstrated a refrigerator in FIG. 16, is 15 a closed 20 door of refrigerator, while FIG. 16, demonstrate a refrigerator with open door. Illustrated is an independent vegetable packing room door, deep freeze/refrigerator door, cold room door and or refrigerators doors, there is nothing not documented in refrigerator until the computer technology, today media communication have transformed every existence into timely program, security, like a mother using a computer, cell phone, and TV to guide a house through lunch and make sure the child eat his/her vegetable or other balanced diet.

The improvement in media have improve life today, we can organize our shopping by inventory check of the refrigerator before returning home, check the house grocery from the subway, office, stadium, or school.

The computer technology have improved the locking technology like discussed earlier in FIG. 1 to 14, the refrigerator may be equip with user ID, and password, screen lock, and the activities and behave of each user is/was record and stored, communicated to other technologies through IP, G4, Satellites, GSM, etc. to parents or other responsible officers of a company. The technological improvement have made it possible for a refrigeration to have Esom security system in all the refrigeration compartments or parts or sections, to gain accesses to refrigeration door, including assess to the compartments, one need the user ID, password, audio video and equipment, code scanning, computer and equipment, electronic equipment or voice recognized or security, with capacity to detect food expiration, carbon, carbon monoxide, and fire. This technological process may be applied to other door, gate, garage and or lock technologies, discussed in FIG. 1 to 14.

FIG. 16. 15 illustrate 77 a refrigerator 29 visual, voice, picture, 30 video (audio) 31 light and media communication that is unprecedented until today, between the user of the refrigerator and the refrigerator, upon inquiry 29 the device 20 (101 computer) sensor pick up or zero on the 109 inventory marked or unmarked and report back to the inquirer, 78 the refrigerator equipped with Esom security apparatus is guided 20 by password, user ID, code and smart card.

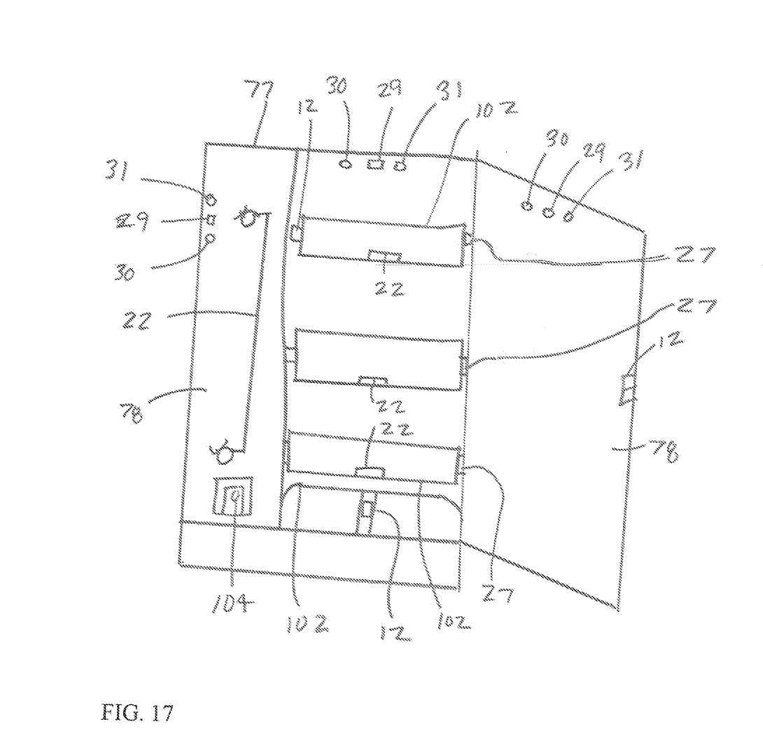

FIG. 17. 115 illustrate further 12 the security (shown an open refrigerator) 8 improvement of each 102 sections of the 27 the refrigerator as the user try to open 78 door, the user of the 77. 20 refrigerate (101 the screen) may have to 1 log in before the door opens, security information from the 101 user in 7 languages, sign, voice, read or written instructions, 34 with all security information answered, the device release 12 lock to the section or sections 27 for the user, the compartment 102 door may open electronically, remote control, automatically or manually when the security is disarmed before 22 pull, slide, push, (horizontal or vertical) the door to open. If the user is seeking 109 inventory 20 which may be readily available using other electronics, computers, cell phone devices in voice, picture, video, E-mail.

Twitter, Facebook to receive inventory inform from the refrigerator without any cost. With Esom security apparatus children do not need additional set to exchange media, especially come home after school, parent can decide what section to save family medicine and lock it with a special password, user ID, smart card, code, etc. without additional cost. Manufacturer bar code can be scanned to log in expiration date (biometric). 34 The keyboard may be touch screen or other form, 65 the keyboard may be remote control, or electronically equipped for horizontal or vertical movement.

According to FIG. 16 and FIG. 17, 77 the refrigerator may be 22 have one or more main 78 doors, and the refrigerator may be cold room, mortuary, freeze, vehicle refrigerator, boat or plane refrigerator. 15 this type of computer device is installed inside the Column of the door of the refrigerator and 32 clip or coupled into the 15 body by a 32 lid screw, thermo, and 57 other mechanical coupling of device inside the door of the refrigerator, making the operating device plug and play (not shown). The device may be installed in any part of the refrigerator thereof.

Esom's security apparatus installed new home lock door as mention above may be capable of upgrade of this lock technologies or and may be configured to better serve the occupant and afford security for all entrances or egress, a powerful 8 processor (1 hard drive). The 8 processor perform high valuable job, 8 the processor receive, interpret, direct the message to appropriate receiver(s), before than 29 the media (34 voice, audio, video, and photo operated by keyboard or other means) is captured by auto configured, 29 camera, 31 flash, and 30 laser guide sensor and or night vision equipment. The 29 camera is configured to respond to the reaction of 30 the very sensitive 29 camera equipment. Once all the information is feed into the 8 processor, the processor determine the danger or damage, or accident, break in the vehicle. The 8 processor will transmit 9 the media 7 the language(s) to the receivers like cell phone, e-mail, printer, Facebook, Twitter, taxi insurance company, police etc. 2 the fan system cool the 4 power (AC, DC, or Solar), the refreshed energy enable configured media in wired and or wireless. The 8 processor or 1 hard ware can enable the store media in a local storage like the system 5 ram or memory, SIM Card, Removable Flash Drive, and elements that use the USB Port, Serial Port, and others ports. Esom's device, 20 in the wireless device is capable of WiFi, Digital compass, G4 and more, IP, Android, GPS, GMS, FM, and other satellite. Esom apparatus is also guide programmed 34, or configured by audio video or visual pad, the 34 screen have LCD or LED equipment, control keyboard, or touch screen, the pad 101 is equip with a touch screen lock technologies, the pad may have an antenna, (not shown). Esom's new smart security apparatus is capable of other wireless media connection like WiFi, G network like G1, G2, G3, G4, and more, Web Cam, Skype, GPS, Android, GMS, FM, other fast satellite technologies, Esom's security apparatus may support the new and improve smart HDTV, computer and electronic equipment.

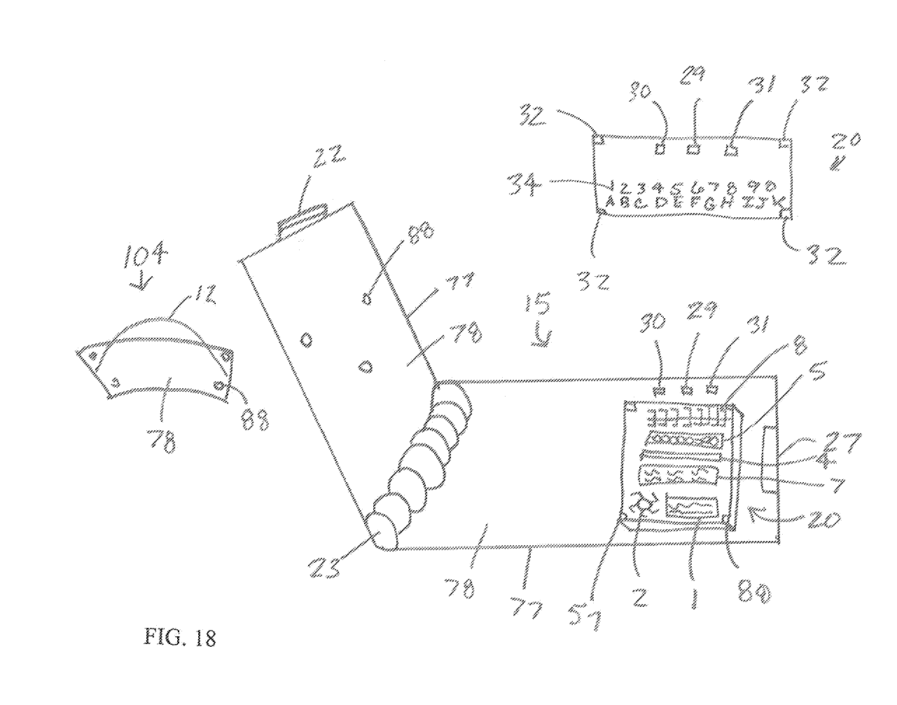

FIG. 18 illustrated hasp, 115 the horizontal section of hasp 88 marking a hole were a mechanical fasten or permanently is drilled, screwed, rivet coupled onto the door, gate, garage, window, tent enclosure. Illustrated above die 115 horizontal section of the hasp, 104 illustrated the hasp interlocking knob, 104 the interlocking knob get attached to the 88 door frame or wall, 88 the drill hole, upright 12 at the door frame may be at a locking distance horizontal or vertical 27 to hasp section. The 15 hasp at the 104 interlocking knob may be locked by pad lock, numbers combination lock, magnet, electronic lock mechanism, etc.

The swing joint 23 of the horizontal section and the 15 vertical section as illustrated in the embodiment of FIG. 18, the operating 20 system (I computer) inbuilt in the vertical section of this embodiment just for the illustration of the embodiment, (the operating system may be built in the horizontal or vertical section of FIG. 18). This operating system, may be the same, up graded or slightly different when applied to this locking systems, independently or inbuilt into door, gate, garage systems or connected to a door like latch, hinges, connectors, and sliding bolt, dead bolt, and hasp.

Esom's security apparatus installed new home lock door as mention above from FIG. 1 to 25 may be linked or upgraded to function with or with the door computer or electronic, HDTV technologies or all of this technologies and may be configured for better media communication and less cost to door occupant, a powerful 8 processor (I hard drive). The 8 processor perform high valuable job, 8 the processor receive, interpret, direct the message to appropriate receivers), before than 29 the media (34 voice, audio, video, and photo operated by keyboard or other means) is captured by auto configured, 29 camera, 31 flash, and 30 laser guide sensor and or night vision equipment. The 29 camera is configured to respond to the reaction of 30 the very sensitive 29 camera equipment. Once all the information is feed into the 8 processor, the processor determine the danger or damage, or accident, break in the vehicle. The 8 processor will transmit 9 the media 7 the language(s) to the receivers like cell phone, e-mail, printer, Facebook, Twitter, taxi insurance company, police etc. 2 the fan system cool the 4 power (AC, DC, or Solar), the refreshed energy enable configured media in wired and or wireless. The 8 processor or 1 hard ware can enable the store media in a local storage like the system 5 ram or memory, SIM Card, Removable Flash Drive, and elements that use the USB Port, Serial Port, and others ports. Esom's device, 20 in the wireless device is capable of WiFi, Digital compass, G4 and more, IP, Android, GPS, GMS, FM, and other satellite. Esom apparatus is also guide programmed 34, or configured by audio video or visual pad, the 34 screen have LCD or LED equipment, control keyboard, or touch screen, the pad 101 is equip with a touch screen lock technologies, the pad may have an antenna, (not shown). Esom's new smart security apparatus is capable or comparable of other wireless media connection like WiFi, G network like G1, G2, G3, G4, and more, Web Cam, Skype, GPS, Android, GMS, FM, other fast satellite technologies. Esom's security apparatus may support the new and improve smart HDTV, computer and electronic equipment.

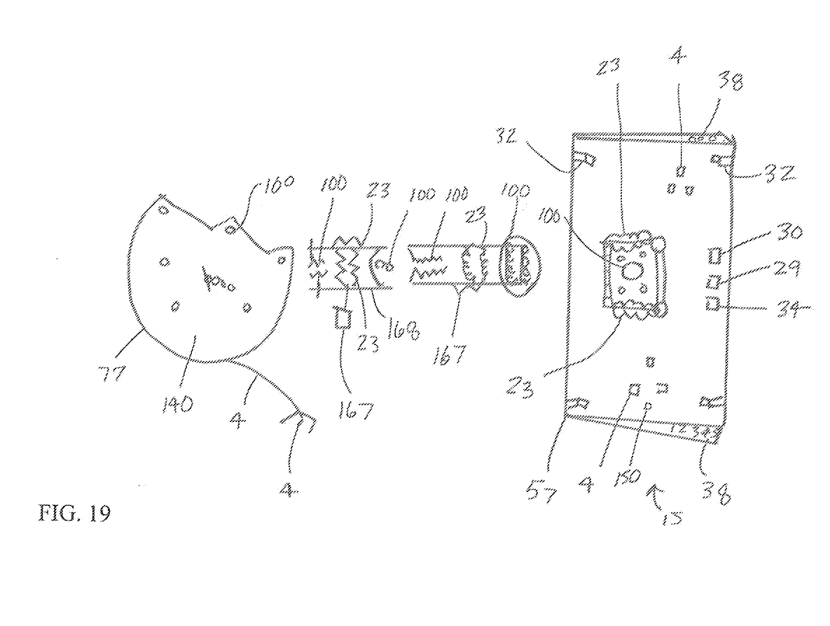

FIG. 19. 15 illustrated a mobile 57 command station, or central station, all sub-station, like houses, apartments, cold rooms, refrigerators, offices, vehicles, warehouses, tents, others may be monitored in a safety of viewing computer and or electronic or HDTV, or HDLCD or HDLED that include voice, video, picture, reading, writing other media communications in a mobile vehicle structure or a stationary command.

Continued, FIG. 19. illustrate 150 a platform, the platform 4 equipped with power out lets for Esom security apparatus like computer, electronic, HDTV items and other mobile safety command station or central station view, 38 illustrated are various serial ports and punch holes for computer or electronic, HDTV LED, web connection 57 inside the platform. At 30 the top of the platform demonstrate the sensor, or 29 camera and light of the platform to communicate media for alternate or emergency use with the computer or not, 32 effective control of Esom security apparatus while in flight or other mobile vehicle motion, 32 the lid like hook stabilized and secure Esom apparatus or items inside the 57 platform. The 100 platform further is secured into the middle aim by means of mechanical fasten, or rivet or screw, the platform may 23 adjustable for better viewing of the user. 57 The platform may be shaped to the mother board, computer, HDTV.

Continue FIG. 19. Illustrated a 15A middle arm, whereas 15 the platform rest 160 on for safety of the operator of the mobile vehicle during security viewing of all or some substation form Esom security apparatus items, the upper 100 level of Esom security apparatus 15A demonstrate the middle 160 resting arm for the 57 platform, the function of 160 die middle arm are switch 167 for the adjustment 23 of the middle 160 arm for the benefit of the operator or viewer, reading or writing, 167 may be used for system locking device, the 160 middle arm may be used for the holder axially or vertical adjustment of the middle arm and lower arm, or include the platform. The lower section 160 illustrate 300 a mechanical tool fasten to 160 connect 15B the middle arm and 15B the 168 lower arm of Esom security apparatus, 168 further demonstrated is the 167 the adjustable handle of 15B part, and also 167 demonstrated in the lower arm is a locking device. 15B illustrated in the bottom of the lower arm 100 is the connecting part to the 15C base 140.

Continued FIG. 19. 15C Illustrated 140 a base, for vertical installation of Esom security apparatus for the comfort of the viewer in mobile vehicle or at homes to view sub stations, the 15C base secured to the floor, 100 connecting 15B to the lower arm of FIG. 19 for axially movement, 100 vertical or axially movement could be manual or electronically control (not shown), 15C As illustrated, 77 the base can receive and distribute 4 power to all Esom apparatus, the 140 base material should demonstrate stable and strength, metal and other solid material might be ideal for the base, and 100 strongly secure on to the base of a mobile vehicle with mechanical tooling.

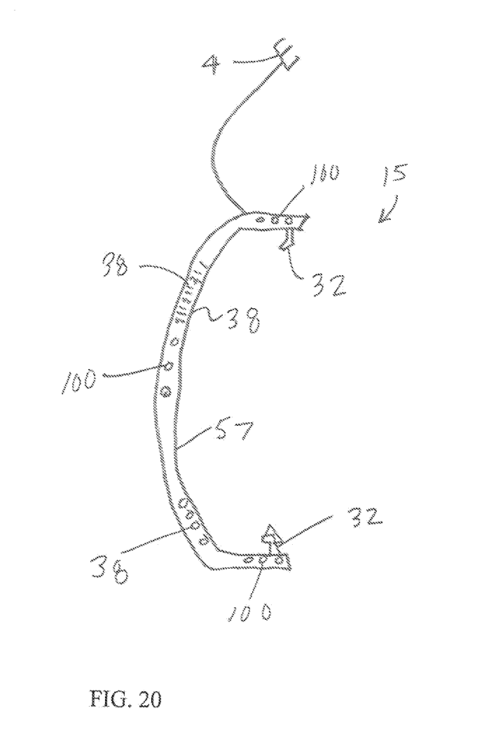

FIG. 20, 15 illustrate a side view of a 57 base for a mobile or home doors, gate garage or structure installation of Esom security apparatus or software, HDTV LCD, Computer, Electronic, Phone or HDTV LED in the like of windows, doors, gates, garages, glass, roof truck, and wall. 57 the base may be installed internally or externally into the structure of home or vehicle. FIG. 20. illustrated images of 100 holes which can be aligned into the structures and secured Esom security apparatus or software, view, voice, video, camera, computer electronics or items by means of mechanical fasten screw or rivet. The base has 4 an expanded function of providing power supply (AC, DC, Solar) to Esom security apparatus, software, or items, 57 the base improved it electronic function 38 to include serial ports and or a 38 punch holes to expose or add more serial ports or channels in Esom security apparatus or items. FIG. 20. 15 The illustrated base 57 may have the capacity to expand or contract in the shape and size of the item it secured to the structure (not shown). May tilt for (keyboard) to accommodate adjoining computers or electronics (not shown). 57 the base may be aligned to the structures, screw, rivet and others.

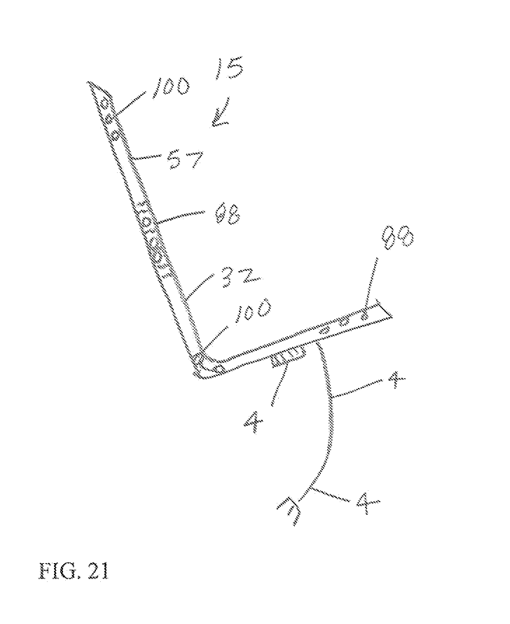

FIG. 21.15 Illustrate a back view and elevated view of a 57 triangle base, base for installation of Esom security apparatus, or software or hard ware or the items, 32 the base may be aligned into structures like mobile vehicles and or homes to secure Esom security apparatus or items onto doors or other structures (computer, electronic, HDTV, HDLED, or HDLCD). The 57 base may be independently or dependency installed into a vehicle or home infrastructure like doors, window, gates, garages, glasses, truck and coupled by likes of 100 rivet, or other mechanical fasting, illustrated at the elevation of the base are holes for a rivet or mechanical attachment methods. The 57 base is improved to adopt or provide serial ports, or channels for Esom security items web connection, the 57 base may have 88 punch holes for ease access Esom security apparatus or items web serial ports and other connections. 57 the illustrated triangle base have 4 power system which enable ease and quick AC, DC, or Solar safe 4 electrical connections to Esom apparatus, software, or items. The 57 base may provide weather proof to Esom security apparatus software, or items. This 57 base may be adequately use in cases when the structure, portion of (install or inbuilt) the door or window, tents enclosure etc.

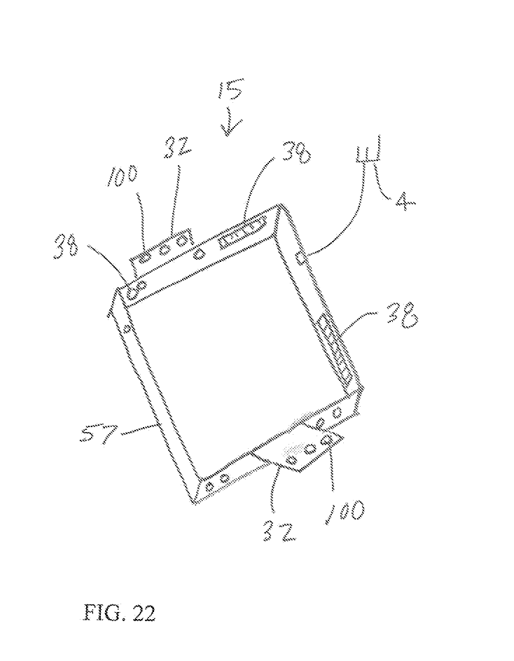

FIG. 22. 15 illustrate a top view of the embodiment of FIG. 22, a square base for structural installation of Esom security apparatus or items in a vehicles or homes, 32 the base may be aligned to structures in mobile vehicles or homes to secure Esom security apparatus or soft wares for items like smart HDTV, HDLCD, HDLED, computer or equipment, electronic and equipment, voice, video, picture, automatic door release and close, enable media communication, exchange of media to local storage or SIM Card, wired or wireless transfer and storage of media //www. (like Facebook, text, E-Mail, command center etc.) the 57 base may be independently or dependently installed into a vehicle or home infrastructures or structures like doors, window, gates, garages, glasses, truck and coupled by likes of 100 rivet, or other mechanical fasting. The 57 base is improved to adopt or provide serial ports, or channels for Esom security items web connection, the 57 base may have 38 punch holes for ease access Esom security apparatus or items web serial ports and other connections. 57 the illustrated square base have 4 power system which enable ease and quick AC, DC, or Solar safe 4 electrical supply and connections to Esom apparatus software or items. The 57 base may provide weather proof to Esom security apparatus and protect items software. 32 Illustrated in the square base may have a lid. This 57 base may be adequately used in cases when the structure or portion to install or (bear) factory inbuilt is door or window, tents enclosure, gate, garage etc. May be aligned to a central stations or substation for the best use of the user. 88 the software may be align in the provided holes by screw, rivet, other mechanical fasten or any alternate align method.

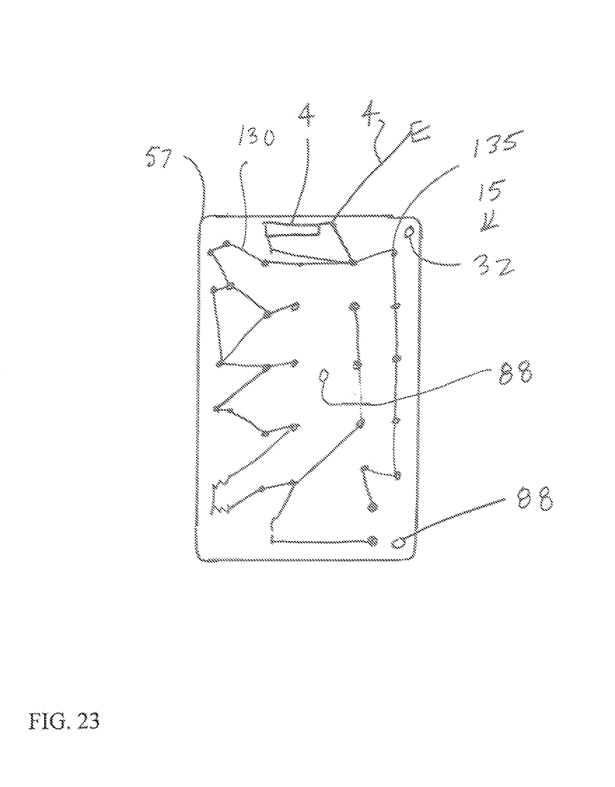

FIG. 23. 15 illustrate a top view of a mother board, FIG. 23 illustrate the (wired) 130 circulation of electricity and communication form the 57 mother board to other parts of Esom security apparatus or items. The 135 plug for parts of the nucleus or SIM conductor or smart parts like hard drive, memory cards, transducer, transmitters etc. 4 the mother board get energized by AC, DC, Solar, Battery power system. The energized system 4 get transmitted or enable communication into the items power supply which 130 distribute the energy 57 to other parts, 57 the body board could be a size or shape of the base it fits.

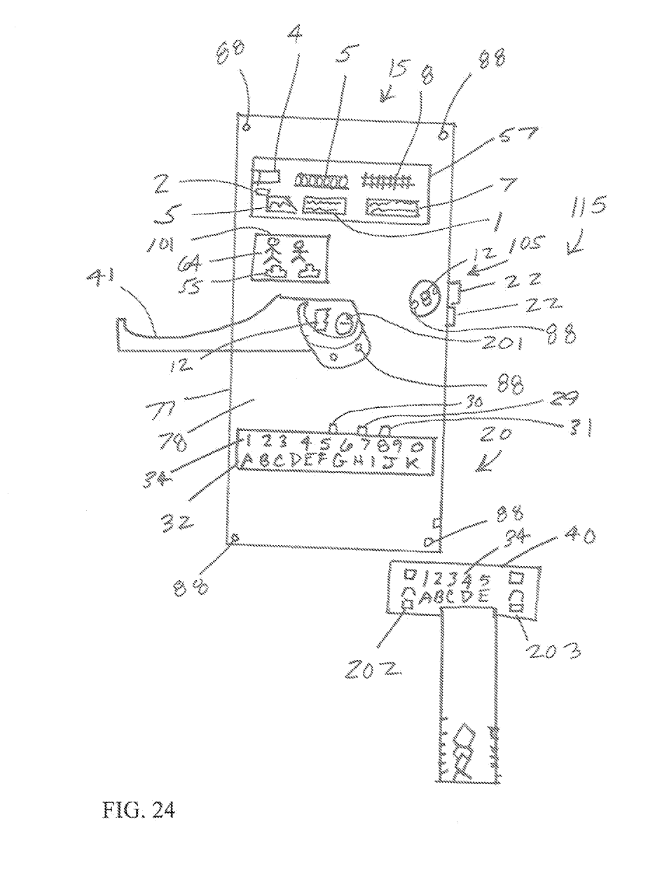

FIG. 24 illustrate a top view of a house, home, tent or apartment door lock, 115 main door, gate, garage, the lock 88 system have holes to attach 115 by screw, rivet, or other mechanical means to attach a door, gate, garage, or window. The 115 locking device is equip 105 at the middle front section a dead bolt, the dead bolt 88 may be assembled or inbuilt into 115 the locking body, skeleton or column, the 105 dead bolt may be electronic lock and 40 unlock, 105 the dead bolt shown in the locking system may be 40 manually or physically locked 12. Physical 105 locking the dead bolt, 40 twist 12 to lodge 22 a projected tip piece of the dead bolt or hook adjustment into the door frame or base for lock (not shown).

Continuing in FIG. 24, At 101 the middle section 115 of the locking device is shown a HDTV, LCD, or LED screen, the 101 HDTV is linked to all electronic and computer security activities for display, diagnostic and educate. 115 the locking device 15 have another operation system, 1.5 the computer operating system. 115 the locking device 41 have handle, as 41 shown the handle may be 40 twisted by a 40 key means 12 to lodge 22 a projected tip piece into a posted door frame or base for locking the door, 88 the hole for installation or assembling, 41 handle and the projecting 22 tip piece may be electronic 12 or manually operated, the 41 handle also future knob 201 for physical or electronically locking.

They 115 have other sensitive electronic and computer connected into lock system, other than Ethernet or satellite operative system, 115 the lock 20 device can lock, unlock, 34 communicate 29 picture, voice, video, 30 light and 31 alarm. 115 future a keyboard system 20 to operate the computer and electronic equipment on the 115 locking system. The system 115 also future a key 40 locking, the 40 key unity, 202 unlocking, 203 lock the locking 11.5 device on to the door electronically 1.5 or through the operating system of the computer, the key system is capable of wireless operating 115 the locking device, if 202 using the press button 203 jam, the 34 keyboard system provide a number operating system in the key. Other locking technology like dead bolt may be configured and incorporated into the above described and illustrated drawing in FIG. 24.

Esom's security apparatus installed new home lock door as mention above may be upgraded computer and electronics technologies or all of this technologies and may be configured to better serve the owner and cost less, a powerful 8 processor (1 hard drive). The 8 processor perform high valuable job, 8 the processor receive, interpret, direct the message to appropriate receivers), before than 29 the media (34 voice, audio, video, and photo operated by keyboard or other means) is captured by auto configured, 29 camera, 31 flash, and 30 laser guide sensor and or night vision equipment. The 29 camera is configured to respond to the reaction of 30 the very sensitive 29 camera equipment. Once all the information is feed into the 8 processor, the processor determine the danger or damage, or accident, break in the vehicle. The 8 processor will transmit 9 the media 7 the language(s) to the receivers like cell phone, e-mail, printer, Facebook, Twitter, taxi insurance company, police etc. 2 the fan system cool the 4 power (AC, DC, or Solar), the refreshed energy enable configured media in wired and or wireless. The 8 processor or 1 hard ware can enable the store media in a local storage like the system 5 ram or memory, SIM Card, Removable Flash Drive, and elements that use the USB Port, Serial Port, and others ports. Esom's device, 20 in the wireless device is capable of WiFi, Digital compass, G4 and more, IP, Android, GPS, GMS, FM, and other satellite. Esom apparatus is also guide programmed 34, or configured by audio video or visual pad, the 34 screen have LCD or LED equipment, control keyboard, or touch screen, the pad 101 is equip with a touch screen lock technologies, the pad may have an antenna, (not shown). Esom's new smart security apparatus is capable or comparable to other wireless media connection like WiFi, G network like G1, G2, G3, G4, and more, Web Cam, Skype, GPS, Android, GMS, FM, other fast satellite technologies, Esom's security apparatus may support the new and improve smart HDTV, computer and electronic equipment.

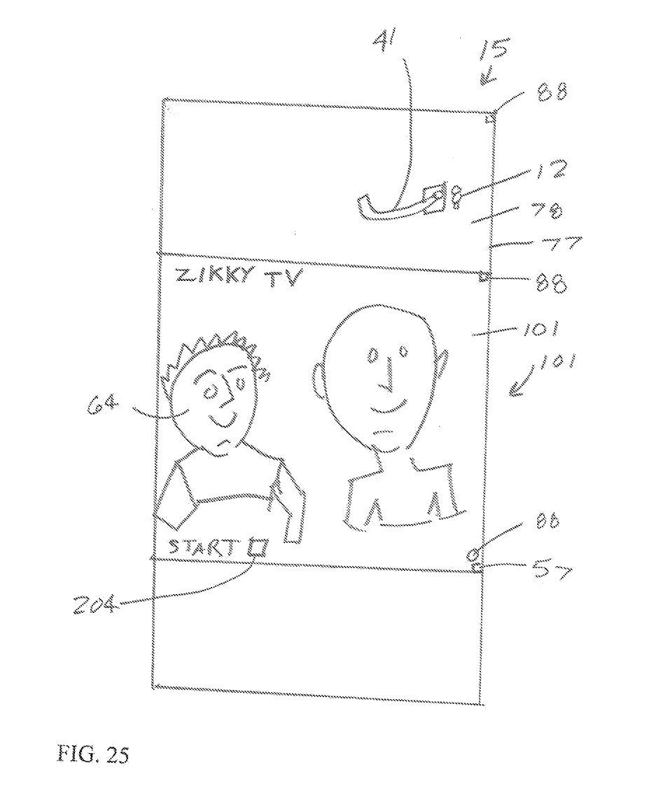

FIG. 25, illustrate a front view of a door, 15 gate, garage door, tent, canopy door, window 88 the door have hole (bracket) to align it to the door frame (not shown), the view HDTV or 77 monitor is clip or install inside the column of the door by screw, rivet or other mechanical method. 101 illustrate the monitor or the HDTV, the 101 HDTV have the capacity to receive media 64 from the 29 (34 voice, 29 audio, video, 30 light, 31 laser sensor). The illustrated door have a 41 manual operation of 12 open and close, or manual 204 log in programming, log-out programming and all or some security programming.

The new 101 HDTV is capable of TV, Audio Video, Computer and much more activities combined in one electronic, 101 the new HDTV does not require any connection to switch to another function, the captured 64 image may be local network or connected WiFi, 4G, or other satellite transited 9 communication. 204 for all the security, computer. Internet TV and other programming, press 204 the control button low left hand side, 204 the start button, list all the digital programming and directory, 15 the door may be equipped with monitors 204 in all side of the door, gate, garage door, tent door.

101 the screen or monitor may be 88 plug and play, repair or place, 57 the double or single digital monitor combined equipment, 1 electronic, 1 computer, 1 audio video, 31 laser, 30 light, 30 night vision, 29 camera (not shown see FIG. 1 to 24). The technologies may be coupled or cased in material such as metal cooper, aluminum, wood, titanium, leather, cloth, plastic, rubber, weather (water) resistance materials, and foam. 57 The 101 LCD (LED) screens or pad base (not shown) may be equipped with 20 water-proof, shock-proof and freeze-proof material(s).

FIG. 25. 20 Esom's security apparatus installed (home) lock door as mention above may be upgrade and may be configured to better serve the occupant, a powerful 8 processor (1 hard drive). The 8 processor perform high valuable job, 8 the processor receive, interpret, direct the message to appropriate receivers), before than 29 the media (34 voice, audio, video, and photo operated by keyboard or other means) may be captured by auto configured, or alternate configured, 29 camera, 31 flash, and 30 laser guide sensor and or night vision equipment. The 29 camera is configured to respond to the reaction of 30 the very sensitive 29 camera equipment. Once all the information is feed into the 8 processor, the processor determine the danger or damage, or accident, break in fee home or vehicle. The 8 processor will transmit 9 the media 7 the language(s) to the receivers like cell phone, e-mail, printer, Facebook, Twitter, taxi insurance company, police etc. 2 the fan system cool the 4 power (AC, DC, or Solar), the refreshed energy enable configured media in wired and or wireless. The 8 processor or 1 hard drive can enable the store media in a local storage like the system 5 ram or memory, SIM Card, Removable Flash Drive, and elements that use the USB Port, Serial Port, and others ports, Esom's device, 20 in the wireless device is capable of WiFi, Digital compass, G4 and more, IP, Android, GPS, GMS, FM, and other satellite. Esom apparatus is also guide programmed 34, or configured by audio video or visual pad, the 34 screen have LCD or LED equipment, control keyboard, or touch screen, the pad 101 is equip with a touch screen lock technologies, the pad may have an antenna, (not shown). Esom's new smart security apparatus is capable or comparable to other wireless media connection like WiFi, G network like G1, G2, G3, G4, and more, Web Cam, Skype, GPS, Android, GMS, FM, other fast satellite technologies, Esom's security apparatus may support the new and improve smart HDTV, computer and electronic equipment.

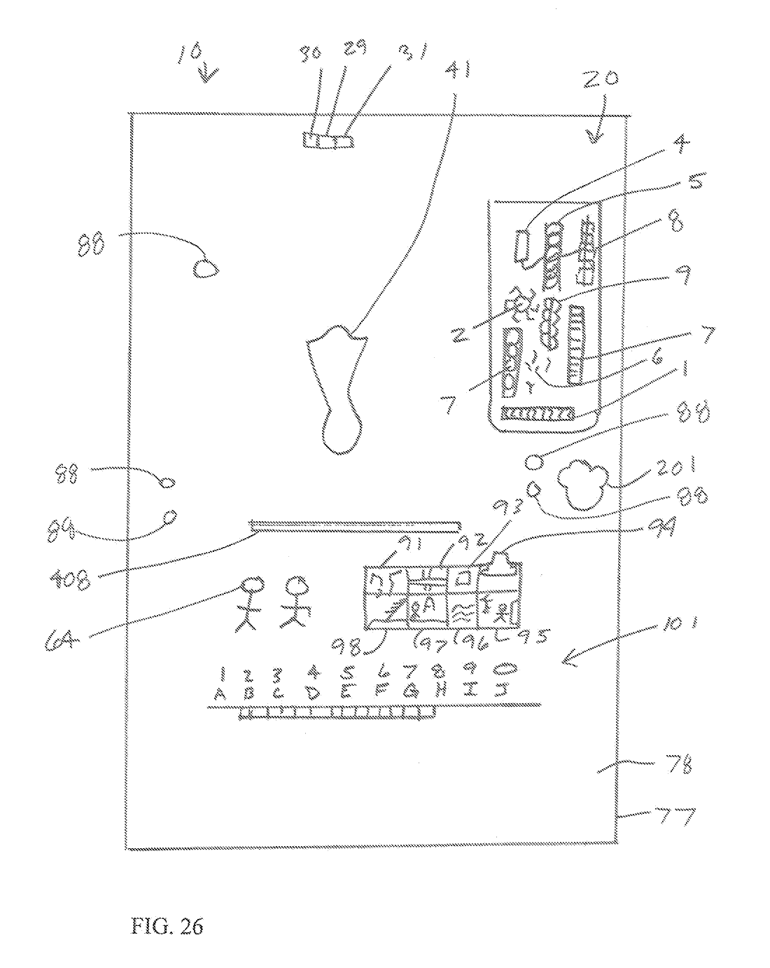

FIG. 26, 10 the new door, lock technology according to the embodiment of Esom security apparatus solve the security need of the occupant and save the life of the would be burglar, while better informing the emergency responders through a link to the (30 sensor and or 31 flash light) premises via wired or wireless 29 camera 101 audio and video, 91 bedroom located upstairs, bedroom 91 door open, the next 92 bedroom have crack on the wall, another 93 upstairs bedroom have sunroom, another upstairs bedroom 94 have chimney, down stair the occupant is opening a door, the next bedroom there 96 is water licking, the next bedroom the occupant is climbing a window, the last bedroom showing entrance/exit, 101 the digital data entry and or touch HDTV may be configured to enable all access or egress, show all occupant enter or exit, 30 configured 29 to capture 31 activities as programmed within the resident or premises, it 20 feed the communication or media as assigned by wired or wireless, accessible by the occupant in a phone, cell phone, 1 Pad, TV, computer and other audible and video electronic.

FIG. 26, 10 In 78 view is door according to Esom security apparatus and the embodiment of FIG. 26, 59 the new 501 lock, base like (see FIG. 20, 21, or 22 or 29) plate covering the back set and or configured 20 operating technologies and or 101 operating HD audio video equipment, 77 door 502 multi lock system, 2nd dead bolt lock, female 38 port that connect or jamb into a male connector at the frame to enable the release of the lock or lock and or other configuration of manual and other alternative configured computer or electronics media to computers and or occupant communication, 38 the port enable Esom security apparatus and all the system to exchange date or occupant to program the system to receive pause each time the new lock system is lock or unlock, the 20 new lock, the new lock 88 have hole and rivet 100 method to align the lock to the door for the durability of the system, door 101 system may be configured to 57 solve the security problem of the occupant by a digital HDTV audio video display right at the occupant new lock 101.

The system is all in one, it a combo of digitized 64 HDTV may enable a one time all screen view of the occupant premises in one channel, 91 shown open double doors, 92 wiring beneath the wails, 93 a bedroom, 94 another bedroom with a sunroof, down stairs, an occupant opening the door, damaged floor 96, 97 the occupant stepping into the bedroom, 97 shown is a stair well to upstairs, 101 this information can be accessed wireless or wired by any portable computer or electronic programmed or linked device, computer 34 electronic system, even 29 a camera system leaser or 3.1 sensor, and 30 a light. 101 the system, computer translate 7 media, the 8 processor transmit 9 the media, the 8 processor or 1 hard can enable storages like 5 memory or ram, SIM card, flash drive, 38 serial ports, WiFi, Twitter, Facebook, text, e mail, 4G network, other satellites. 1 should be known as the computer hard drive, 20 Meaning the 1 computer and electronic may exchange media wired or wireless, the system power 4 source is located on the lower right side, the durable 6 sever, 8 processor, 5 memory, 7 language translator, 9 transmitter, 1 PC, 2 the system cooling fan is located at the right side, system power 4 supply may be AC, DC, solar.

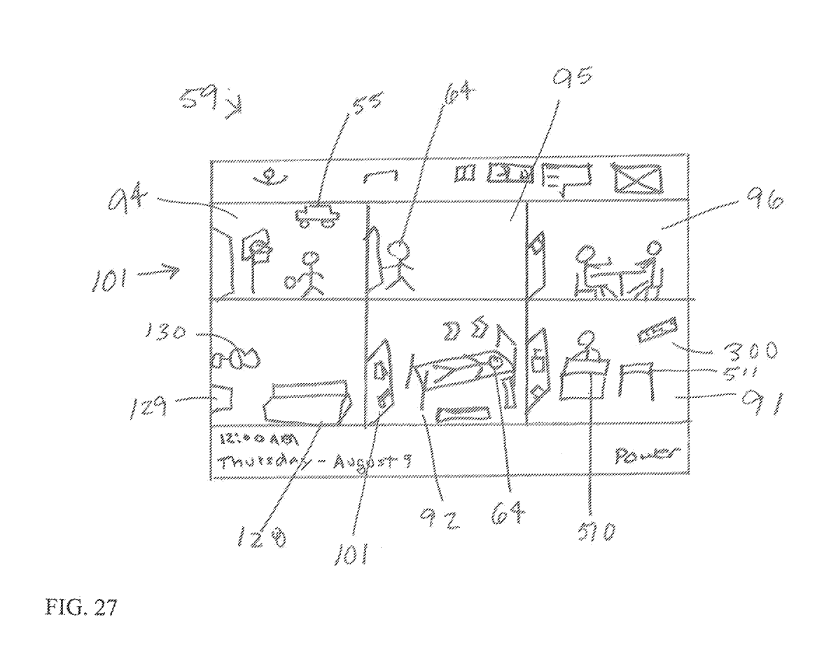

FIG. 27, 101 the security problem of the 21st century may have been solved 101 by the application of Esom security apparatus in the new key lock technology, the challenges of access, egress and other occupant security problems and emergency rescue, Esom security apparatus have produce new smart key, see FIG. 25, or FIG. 26, the new smart key is all in one, locking ability, wired or wireless media exchange, the new lock have the capacity to read, write, text, e mail, to the occupant showing all the problem spot and the occupant can make decision on her security matters.

Continue in FIG. 27, 101 the new lock operative wire or wired, the occupant 59 meaning the occupant can access his home view from his hand held tablet PC like iPad or cell phone. FIG. 27, shown is a Esom security apparatus automatically or by the request of the occupant telecasting live activities the occupant home, this is locking technology in the cutting edge, the new key technology, see FIG. 1 to FIG. 27. Esom security apparatus has proved that the new smart, keys is reliable, dependable, durable more than human and it cost less to occupants. The new Esom smart lock is 38 internet ready, HDTV, read, write, e mail, Facebook, Twitter, text, WiFi, 4G, GMC other satellite, audio, video, camera and light, the smart lock 1 is equip with high volume ram for storage, flash drive, hard drive. The smart key may be programmed to alert occupants or other emergency respondent equip the with minute to minute information data and position of problems 101 like seen in FIG. 27, 59 from the top floor, occupant doing laundry, 510 loading up the washing machine, and 511 the dry machine. 92 it shown another occupant resting, still at upstairs 93, the occupant and or a responder is look at the rest room, 128 the bathtub, 129 the sink, 130 and toilet bowl.

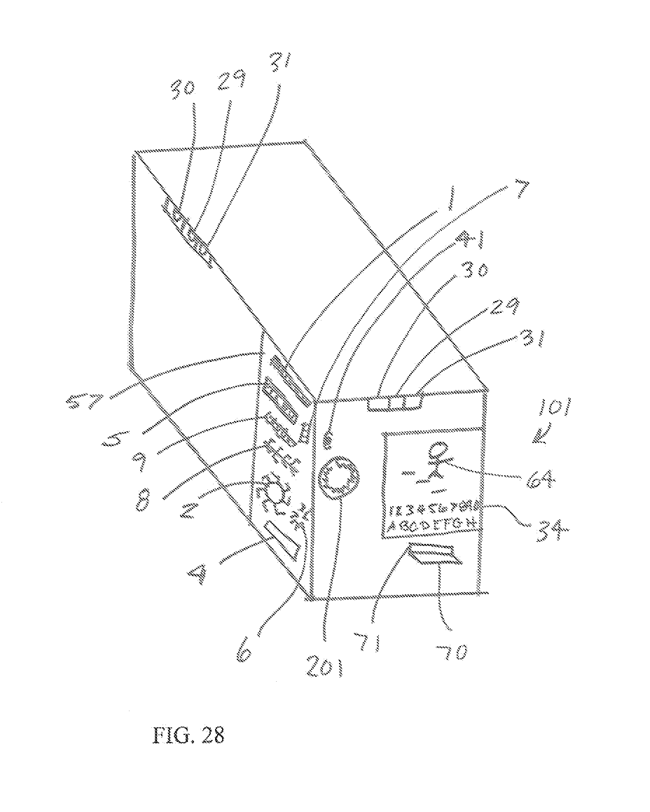

FIG. 28, 10 illustrated a save (safe) deposit box according to Esom security apparatus, it 77 illustrate a new save deposit box lock system, the old deposit box has a lot of deficiencies in providing adequate security to home occupants and small business owners and or emergency responders, it lack lock devices Esom security may provide, all in one security equipment, a powerful new lock device in 29 HD camera, a night 30 motion detector or laser equipped sensor, 31 power light (as mention from FIG. 1 to FIG. 29 equipment are internet ready).

The old save deposit box was prone to disappear without trace, the new 20 computer or electronic equipped safe deposit key lock box provided by Esom security provide minute to minute safety information activities in-around the save deposit box to the occupant of the home or to would be emergency responders.

Esom security apparatus with the configuration of all in one, or any other alternate arrangement of all in one configuration, computer, electronic, lock back set, dead bolt, remote lock, motor operated locks, slide, up-lift, side, down lift motor operated, sensor operated, etc., provides to the safe deposit lock box a 8 powerful processor, enable or disable or 1 the hard drive that process all media 34 or data, 29 captured or 34 data entry, or 41 key or other access to the safe deposit box. 5 the new save deposit lock is equipped with a large gig capacity of 5 memory, and 7 translated media or data or data entry, communication may become 9 transmitted wired or wireless 6 to the owner, occupant, designated receivers or emergency responders, the hard 2 working 1 PC is equipped with cooling 2 fan. The 1 PC may transfer or exchange media via text, e mail, transfer 9 phone alert or other alarms and to many programmed receivers, for 4 security reasons energy supply may include rechargeable battery, AC, DC, and or solar energies. The save deposit box lock 201 may be equipped with handle (41 key, not shown) for manual opening, or remote opening (not shown). The new save deposit box. 101 may be equipped with a HDTV with inbuilt access code, or other security access code, like card opening device (not shown). The new save deposit box may be equipped with the technology to dispense money and 70 accept (not shown) 71 deposit without 41 unlocking the 210 door, online check deposit, and other on line banking, camera may include a time, light and night vision camera or powerful lens (not shown).

The computer technology have improved the locking technology like discussed, earlier in FIGS. 1 to 29. the safe deposit box may be equip with user ID, and password, screen lock, and the activities and behave of each user is/was record and stored, communicated to other technologies through IP, G4, Satellites, GSM, etc. to occupants, owner or other responsible officers of a company. The affordable technological improvement have made it possible for a safe deposit box to have Esom security system in all the safe deposit lock box or compartments or parts or sections, to gain accesses to safe deposit box door, including accesses to the compartments, one need the user ID, password. Audio video and equipment recognize, code scanning, computer to equipment, electronic equipment or voice recognized security, with capacity to detect ID, or card expiration, carbon, GPS tracking system, other satellite tracking, carbon monoxide, and fire. This technological process may be applied to other door, gate, garage and or lock technologies, discussed in FIGS. 1 to 29.

Continue in FIG. 28, the new all in one technology in safe deposit box lock have capability for voice mail 34 audio video, or picture voice mail, announcements, prior recorded announcement or instruction, user directory and occupant live announcement capability wired or wireless the new smart safe deposit lock box 57 may be case in a door column or 57 a base.

FIG. 28, 20 Esom's security apparatus installed new home lock door as mention above may be upgraded with this technologies or all of this technologies and may be configured to better serve the occupant and costless, a powerful 8 processor (1 hard drive). The 8 processor perform, high valuable job, 8 the processor receive, interpret, direct the message to appropriate receiver(s), before than 29 the media (34 voice, audio, video, and photo operated by keyboard or other means) is captured by auto configured, 29 camera, 31 flash, and 30 laser guide sensor and or night vision equipment. The 29 camera is configured to respond to the reaction of 30 the very sensitive 29 camera equipment. Once all the information is feed into the 8 processor, the processor determine the danger or damage, or accident, where and who is handing the safe deposit. The 8 processor will transmit 9 the media 7 the language(s) to the receivers like cell phone, e-mail, printer, Facebook, Twitter, taxi insurance company, police etc. 2 the fan system cool the 4 power (AC, DC, or Solar), the refreshed energy enable configured media in wired and or wireless.

The 8 processor or 3 hard drive can enable the store media in a local storage like the system 5 ram or memory, SIM Card, Removable Flash Drive, and elements that use the USB Port, Serial Port, and others ports. Esom's device, 20 in the wireless device is capable of WiFi, Digital compass, G4 and more. IP, Android, GPS, GMS, FM, and other satellite. Esom apparatus is also guide programmed 34, or configured by audio video or visual pad, the 34 screen have LCD or LED equipment, control keyboard, or touch screen, the pad 101 is equip with a touch screen lock technologies, the pad may have an antenna, (not shown). Esom's security apparatus is capable of other wireless media connection like WiFi, G network like G1, G2, G3, G4, and more, Web Cam, Skype, GPS, Android, GMS, FM, other fast satellite technologies, Esom's security apparatus may support the new and improve smart HDTV, computer and electronic equipment.

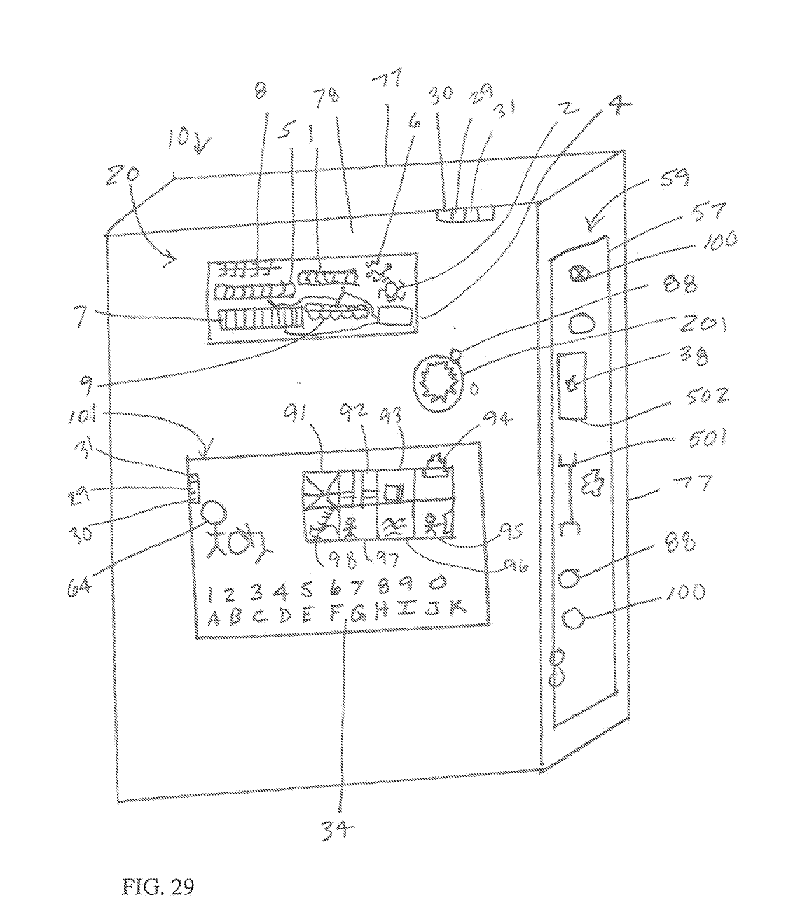

FIG. 29. 10 according the embodiment of Esom security apparatus demonstrated a new 10 door, wood door, chromium stainless nickel door, aluminum door, fiber, glass, vinyl, glazing door, etc.

According to the embodiment of FIG. 29,20 Esom security apparatus 10 provide a new security at the cutting edge for a house occupant in the 21st century. 10 door 20 equipped high tech solutions, providing 29 audio 30 video 31 laser guide light, camera, sensor, 1 configured network technology, impressive 8 media exchange 9, unlimited access 5 of media storage, data or image enhancement 7 and translation 6, 99% reliance, dependable, 20 stable and durable more than human, 20 the computer or electronic may be refreshed 4 by solar, AC, DC energy source.

FIG. 29, 10 Esom security door locking device 41 equipped with a key locking device (not shown) see FIG. 7, 40. The 41 key device may be configured 101 numerically or words 20 to enable the occupant to use the key device to open or close the 10 door. The same is applicable to the 408 card system, 408 the inbuilt device, smart chip may be configured or programmed to read or enable access to the occupant 20 by the inbuilt computer or electronic devices, the occupant may assign as many code as possible because the computer have unlimited 5 memory capacity.

Continue FIG. 29, 41 the device may be equip with a beeper, or alarm when unauthorized use, the alarm or alert equipment media or signal may be received by occupant or any other designated responder, the same applied 408 to the card device. The hand may 201 also be 101 configured 20 to enable or disable, open or and close, allow or disallow a user. Other method of security configuration the occupant may choose because the computer technology of the new Esom's lock is limitless. The likes of new deposit save box may be equipped with Esom's security apparatus to dispense or exchange, or transfer money for the occupant (not shown).

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive and all modifications which would be obvious to those skilled in the art are therefore, intended to be embraced therein. It will further be understood that any reference herein to known prior art does not, unless the contrary indication appears, constitute an admission that such prior art is commonly known by those skilled in the art to which the invention relates.

It should be appreciated from the above disclosure that the invention relates to new smart lock technology systems for homes and vehicles. All in one systems, computers, and electronic devices provide sensor motion detector, light voice, video, camera, motorized back lock, and picture configuration to a pad lock, key lock, combination key, remote control key, and/or locking body(s), doors, gates, garages, and windows, glass, mirror. Physical locking methods, shapes, and sizes may change to allow HDTV, computer, and/or electronics devices in a coupled base. Other elements that may combined, to forge the new smart lock material(s) in homes and vehicles, like gates, doors, garages, car boots, glasses, mirrors, windshields, window technology systems may include one or many materials like mirrors, concrete, sheet rock, glass, metal, cooper, aluminum, wood, titanium, leather, cloth, plastic, rubber, liquid nails, seal and foam, plate and plate lid. A base may be sophisticated and electronically designed to receive and read the device with electronics such as a computer inbuilt and other technology such as USB ports, VGA ports or other serial ports and holes or clips for attachment.

The new lock security apparatus can be installed on every home as mentioned above with new all in one upgrade lock technologies may be configured to better serve the occupant, with a powerful 8 processor (computer). The processor performs high valuable job. The processor receives, interprets, directs the message to appropriate receiver(s). Before that, the media (voice, audio, video, and photo) may be captured by using night vision detector, laser, or motion detector (or other means), such as an affordable auto configured camera, flash, and 30 laser guide sensor and or night vision equipment. The camera is configured to respond to the reaction of the light and laser, or other sensitive camera equipment. Once all the information is fed into the processor, the processor is programmed to determine the danger or damage, accident, or break in the lock. The processor will transmit the media in the language(s) to the receivers like cell phone, e-mail, printer, Facebook, Twitter, taxi insurance company, police etc. The fan system cools the power (AC, DC, or Solar). The refreshed energy enables configured technology, media or communication in wired and or wireless. The processor (computer or electronic) or hard drive may enable the stored media in a local storage like the system ram or memory, SIM Card, Removable Flash Drive, and elements that use the USB Port, Serial Port, and others ports. The hard drive in the device enables or disables in the wireless media communication in WiFi, Digital compass, G4 and more, IP, Android, GPS, GMS, FM, and other satellite. The security apparatus or lock processor (computer and electronic) may also guide programs configured by audio video or visual pad. The screen has HDTV, LCD or LED equipment, control keyboard, or touch screen. The pad is equipped with touch screen lock technologies. The pad may have an antenna (not shown). The security apparatus is capable or compatible of other wireless media connections like WiFi, G network like G1, G2, G3, G4, and more, such as Web Cam, Skype, GPS, Android, GMS, FM, other fast satellite technologies. The security apparatus may support the new and improved smart HDTV, computer and electronic equipment.

The new smart lock technology of the invention has the capability of communicating voice, image and video into a storage system. The new locking technology devices may store media in a local memory like SIM cards, chips, and external receivers, like computers, electronic, cell phone, phone, remote printer, Twitter, e-mail, Facebook, police, LCD PAD, or any address assigned.

The new smart lock technology of the invention can be an all in one new lock with smart HDTV, iPad, electronics, computers, smart adopter and camera, LCD pad, light, camera, night, vision camera and/or the equipment may be integrated or configured to function and or install with a door, gate, garage door, window, tent enclosure or door.

The new smart lock device of the invention can be a home or vehicle locking system, Electronic, and/or computer operating system, or control pad of the locks or lock bodies may be equipped with wired or wireless technologies connectors or outlets to add or connect media to multiple new and improved device(s) independently or dependent like audio video, computer, electronic, including serial port, VGA, USB port, Twitter, e-mail, Facebook, local police website, private command center, personal cell phone, remote computer, remote electronic devices and inbuilt HD LCD attached to the lock or the lock body.

The new smart lock technology of the invention can be a home or mobile vehicle locking technology that is a pad lock, combination lock, dead bolt, or latch, key lock, remote control lock, motorized back lock, frame base lock and the locking body.

The new smart locking device of the invention can be for home aid vehicle key lock, combination lock and the locking bodies with all in one like doors, windows, windshields, garages, glass, mirror, laser sensor motion detector, light, alarm, camera that communicate with other inbuilt technology unit capture images from different angles and transmits media by computer, or server, or SIMO, or other electronics device.

The new smart lock technology of the invention can be a new smart lock with pad LCD or LED screen in a car, or house, door, trunk, roof, bonnet, and built independent or dependent in the lock, door or assembled to communicate media to other devices internal or external.

The new smart lock technology of the invention can have an operating capability of providing reliable, and dependable security to all entrance and or egress to all point in the house in an affordable manner. The technology can also be programmed or configured to recognize, communicate, announce, dialog, receive picture or video voice mail, audio video, educate an intruder, cell phone alert and other computer and electronic alarm, and provide information to emergency, clock, temperature, read, and write.

The new smart lock technology of the invention can have a lock device configured to high volume media storage, internally and externally (chip memory card, V card, self-recorder mode), HDTV, computer or electronics, e-mail, text, Facebook, police and Twitter as a receiver.

The new smart lock technology of the invention can equip the occupant of a home and/or vehicle with a device that allows a centralized view of substations. The occupant can view the house from the vehicle, or view his vehicle from the house before entering the house or vehicle using a cell phone, iPad, computer, HDTV, and electronics.

The new smart lock technology of the invention can inform and educate an intruder, direct emergency responders through voice and video, life and time picture or diagrams of hot spot in the location, automatically send media to internal and external storage like SIM card, computer, electronic, private control station, police command website, Facebook, cell phone alert.

The new smart lock technology of the invention can allow an occupant to view her infant in a back seat or any seat in a vehicle and view from a windshield, mirror, glass, without distraction to the driver. The new smart lock technology of the invention can also allow the occupant at an office to view a child or children at home using HDTV, cell phone, Twitter, Facebook, or substations to central station.

The new smart lock technology of the invention can be a steering wheel lock having a combination of materials, including metal, aluminum, plastic or rubber. The new steering wheel lock apparatus may be equipped with a computer, and or electronic operating system. The new steering wheel lock technology may be capable of voice, alarm, alert, video, and time picture, automatic locking and engine stop system technology, code, password security, key, leaser sensor, camera, light, wired wireless media communication.

The new smart lock technology of the invention, with computer or electronic technology, can restrain the turning or physical control of the steering wheel, and can be capped with configuration or upgrade lock system computer, alarm, camera, laser detector sensor, light. It can also communicate voice, video and picture through LCD wired and or wireless devices, like SIM card, flash drive, WiFi, cell phone, HDTV, LED, HDTV, website, private station. The new smart steering locks may be any shape and size, external or internal, and install with a key or remote control or number combination lock.

The security apparatus of the invention for home and vehicles may be built and\or installed with a light tools, heavy tools, plate holder, a plate holder lid, base, glue, zip, Velcro, magnet, nails, liquid nail, foam, brackets, bolts, handles, thermo and welding, install water proof, freeze proof, and electric shocking proof, serial port, punch hole and or electric shock equipment.

The new smart lock device of the invention can have a LCD screen, HDTV, which is a touch screen, flip type, pull up, pull down, slide type, motorized or electronic control remote. The screen can be a lock screen with password, keyboard or a key lock and occupant device activation such as by cell phone or iPad.

The new smart lock technology of the invention can be programmed to disable or enable a door or mobile vehicle operating system, and the security application can be down loaded into a cell phone, computer, or electronics for occupant use.

The new smart lock technology can be applied to a door, frame, key, gate, garage, sunroof, window, canopy door, or tent.

The new smart lock technology of the invention can be a smart lock or all in one camera, HDTV, and or LCD, and or HD LCD, and or computer, wired and or wireless media, electronic and or, Audio Video, and or back set, and or dead bolt, and or number lock, and or key lock, and or motor driven lock, light, and or fire alarm, and or alarm, and or gas detector, and or fire detector, and or motorized back lock, and or manual lock hardware and or accessories, and or new smart lock parts and accessories, and or new smart lock computer application and software, and or new smart lock electronic applications and software.

The new smart lock technology of the invention can be provided in a new all in one safe (save) deposit box. The new smart lock safe deposit box may be capable of on line banking and on line software application, password, personalized ID and factory inbuilt verification.

1. A smart lock system for homes and vehicles all in one system, the system comprising computer and electronic devices including sensor motion detector, light, voice, video, camera, motorized back lock and picture configuration to pad lock, key lock, combination key, remote control key and or it locking body (s) doors, gates, garages, and windows, glass, mirror.

2. A smart lock system according to claim 1, that have the capability of communicating voice, image and video into a storage system, the new locking technology devices may store media in a local memory like SIM cards, chips, external receivers, like computers, electronic, cell phone, phone, remote printer, twitter, e-mail, face book, police, LCD PAD, any address assigned.

3. A smart lock system according to claim 1, all in one new lock with smart HDTV, I Pad, Electronics, computers, smart Adopter and camera, LCD PAD, light, camera, night vision camera and or equipment may be integrated or configured to function and or install with the door, gate, garage, window, tent enclosure or door.

4. A smart lock system according to claim 1, whereas home or vehicle locking system electronic, and or computer operating system, or control pad, of the locks or lock bodies maybe equipped with wired or wireless technologies connectors or outlets to add or connect media to multiple new and improved device(s) independently or dependant like Audio Video, computer, electronic, including serial port, VGA, USB port, twitter, e-mail, face book, local police website, private command center, personal cell phone, remote computer, remote electronic devices and inbuilt HDLCD attached to the lock or the lock body.

5. A smart lock system according to claim 1, whereas it is a home or mobile vehicle locking technology that is a pad lock, combination lock, dead bolt, or latch, key lock, remote control lock, motorized back lock, frame base lock and the locking body.

6. A smart locking system according to claim 5, for home and vehicle key lock, combination lock and the locking bodies with all in one like doors, windows, windshields, garages, glass, mirror, laser sensor motion detector, light, alarm, camera that communicate with other inbuilt technology unit capture images from different angles and transmits media by computer, or server, or SIMOS, or other electronics device.

7. A mw smart lock system according any proceeding claim, a new smart lock with pad LCD or LED screen in a car, or house, door, trunk, roof, bonnet, built independent or dependent in the lock, door or assembled that communicate media to other devices internal or external.

8. A smart lock system according to anyone of claims 1 to 6 that have an operating capability of providing reliable, and dependable security to all entrance and or egress to all point in the house and affordable. Programmed or configured to recognize, communicate, announce, dialog, receive picture or video voice mail, Audio video, educate an intruder, cell phone alert and other computer and electronic alarm, and provide information to emergency, clock, temperature, read, and write.

9. A smart lock system according to any one of claims 1 to 6, in as the new lock device is configured to high volume media storage, internally and externally (chip memory card, V card, self-recorder mold), HDTV, computer or electronic, e-mail, text, face book, police and tweeter as receiver.

10. A smart lock system according to any one of claims 1 to 6, that equip the occupant of a home and or vehicle a device that allows a centralized view of substations. To view house from vehicle, or view his or vehicle form the house before entering the house or vehicle. Cell phone, I Pad, Computer, HDTV, and Electronic.

11. A smart lock system according to claim 7, that inform and educate an intruder, direct the emergency responders through voice and video, life and time picture or diagrams of hot spot in the location, automatically send media to internal and external storage like SIM card, computer, electronic, private control station, police command website, face book, cell phone alert.

12. A smart lock system according to claim 7, that allow an occupant to view her infant in a back seat or any seat in a vehicle and view from windshield, mirror, glass, without distraction to the driver. The new smart lock technology allow the occupant at office to view child or children at home from HDTV, cell phone, tweeter, face book, substations to central station.

13. A smart lock system according to claim 7, whereas the new smart sterling lock maybe a combination of materials, metal, aluminum, plastic or rubber, new smart lock apparatus maybe equipped with a computer, and or electronic operating system, the new smart sterling lock technology may be capable of voice, alarm, alert, video, and time picture, automatic locking and engine stop system technology, code, password security, key, leaser sensor, camera, light, wired wireless media communication.

14. A smart lock system according to claim 7, with computer or electronic technology, the new smart sterling lock restrain the turning or physical control of the sterling wheel, capped with configuration or upgrade lock system computer, alarm, camera, laser detector sensor, light. Communicate voice, video and picture through LCD wired and or wireless devices, like SIM card, flash drive, WiFi, cell phone, HDTV, LED, HDTV, website, private station. The new smart sterling locks maybe any shape and size, external or internal install with a key or remote control or number combination lock.

15. A smart lock system according to claim 1, wherein the lock is water proof, freeze proof, and electric shocking proof.

16. A smart lock system according to claim 7, wherein said LCD screen, HDTV, maybe touch screen, flip type, pull up, pull down, slide type, motorized or electronic control remote. Lock screen, password, key board or a key lock, occupant device activation, cell phone or tablet computer.

17. A smart lock system according to claim 1, wherein lock is programmed to disable or enable, door or mobile vehicle operating system, and the security application can be down loaded into cell phone, computer, or electronic for occupant use.

18. A smart lock system according to claim 1, wherein the lock is applied to one of a door, frame, key, gate, garage, sunroof, window, canopy door, and tent.

19. A smart lock system according to claim 1, wherein the new smart lock or all in one camera, HDTV, and or LCD, and or HD LCD, and or computer, wired and or wireless media, electronic and or, Audio Video, and or back set, and or dead bolt, and or number lock, and or key lock, and or motor driven lock, light, and or fire alarm, and or alarm, and or gas detector, and or fire detector, and or motorized back lock, and or manual lock hardware and or accessories, and or new smart lock parts and accessories, and or new smart lock computer application and software, and or new smart lock electronic applications and software.

20. A smart lock system according to claim 1, wherein the all in one Esom security lock apparatus in a new smart lock technology provided a new all in one for safe (save) deposit box, the new smart lock safe deposit box maybe capable of on line banking and on line software application, password, personalized ID and factory inbuilt verification.

21. (canceled)
